(19) United States
(12) Patent Application Publication
(10) Pub. No.: US 2017/0297446 A1
(43) Pub. Date: Oct. 19, 2017

(54) ELECTRODE-ATTACHED COMMUNICATION TERMINAL, COMMUNICATION TERMINAL, COMMUNICATION SYSTEM, ELECTRIC VEHICLE, AND CHARGING APPARATUS

(71) Applicant: Panasonic Intellectual Property Management Co. Ltd., Osaka (JP)

(72) Inventors: AKIHIKO NAMBA, Osaka (JP); HIROKAZU KITAMURA, Osaka (JP)

(21) Appl. No.: 15/514,059

(22) PCT Filed: Nov. 27, 2015
(86) PCT No.: PCT/JP2015/005901

§ 371 Date: Mar. 24, 2017

(30) Foreign Application Priority Data
Dec. 18, 2014 (JP) 2014-256663
Jan. 15, 2015 (JP) 2015-006099

(51) Int. Cl. B60L 11/18; H02J 7/00; H04B 3/56

(52) U.S. Cl. CPC B60L 11/1846; H04B 3/56; H02J 7/0027; H02J 7/0045; B60L 11/1818; B60L 2230/16; H04B 2203/5466; H04B 2203/5483; H02J 2007/0001

(57) ABSTRACT

A communication unit of a communication terminal is provided in a first device and communicates with a destination terminal provided in a second device that exchanges a resource with the first device through a supply line. The communication unit includes a connection terminal electrically connected to an electrode. The electrode is disposed with a space from a conductive member including at least one of a first conductor included in the supply line and a second conductor electrically connected to the first conductor, thereby being coupled via electric field to the conductive member. The communication unit is configured to communicate with the destination terminal by using a signal transmitted via the conductive member as a medium. This communication terminal performs one-to-one communication even when plural devices that can be communication destinations exist near one device.

### TECHNICAL FIELD

The present invention relates to an electrode-attached communication terminal, a communication terminal, a communication system, an electric vehicle, and a charging apparatus, and more particularly to an electrode-attached communication terminal, a communication terminal, a communication system, an electric vehicle, and a charging apparatus used for communication between devices exchanging a resource.

### BACKGROUND ART

PTL 1 discloses a conventional power line connection device control system that allows automatic recognition of a type of electric device connected to each connection port (outlet) of a connection device. A power line carrier signal transmit-receive system is applied to the system described in PTL 1. A home server (control apparatus) is connected to a power line via a power line communication (PLC) modem. In this system, when an electric device that complies with the standard for power line carrier signal transmit-receive system is connected to the plug socket, the electric device exchanges signals with the home server via the power line and the PLC modem, and then a recognition process is performed.

However, since this system requires wiring work to connect the PLC modem directly to the power line, it is difficult to provide a communication function to an existing device later. When a power line to which relatively high voltage (for example, AC 200 V) is applied is used, the PLC modem may require relatively high-withstand-voltage components.

Meanwhile, PTL 2 discloses, for example, application of short-range wireless that uses an electromagnetic wave for communication between an electric vehicle such as an electric-powered vehicle and a charging stand that supplies electric power to the electric vehicle. In the charging stand described in PTL 2, the communication with the electric vehicle is used, for example, for a billing process according to an amount of charging or the like.

### CITATION LIST

### Patent Literature

PTL 1: Japanese Laid-Open Publication No. 2003-110471

PTL 2: Japanese Utility Model No. 3148265

### SUMMARY

A communication unit of a communication terminal is provided in a first device and is configured to communicate with a destination terminal provided in a second device that exchanges a resource with the first device through a supply line. The communication unit includes a connection terminal electrically connected to an electrode. The electrode is disposed with a space from a conductive member including at least one of a first conductor included in the supply line and a second conductor electrically connected to the first conductor. The electrode is configured to be coupled via electric field to the conductive member. The communication unit is configured to communicate with the destination terminal by using a signal transmitted via the conductive member as a medium.

This communication terminal can perform one-to-one communication even when plural devices that can communicate exist near one device.

### BRIEF DESCRIPTION OF DRAWINGS

FIG. 1 is a schematic block diagram of a communication system according to Exemplary Embodiment 1.

FIG. 2 is a configuration diagram of a charging system that uses the communication system according to Embodiment 1.

FIG. 3 is a perspective view of a main part of an example of an installed a first communication terminal according to Embodiment 1.

FIG. 4A is a perspective view of a main part of an electrode according to Embodiment 1 for illustrating an installing process thereof.

FIG. 4B is a perspective view of the main part an installed electrode according to Embodiment 1.

FIG. 4C is a perspective view of a charging cable which is a supply line according to Embodiment 1.

FIG. 4D is a perspective view of the main part of another example of the installed first communication terminal according to Embodiment 1.

FIG. 5A is a perspective view of a main part of the electrode according to Embodiment 1 for illustrating an installation process thereof.

FIG. 5B is a perspective view of the main part the installed electrode according to Embodiment 1.

FIG. 6A is a cross-sectional view of a main part of an example of the electrode according to Embodiment 1.

FIG. 6B is an enlarged sectional view of the electrode illustrated in FIG. 6A.

FIG. 7A is a perspective view of a main part of an example of an installed second communication terminal according to Embodiment 1.

FIG. 7B is a perspective view of the main part of an example of the installed second communication terminal according to Embodiment 1.

FIG. 8 is a perspective view of a main part of an example of an installed first communication terminal according to Exemplary Embodiment 2.

FIG. 9 is a perspective view of the main part of an example of an installed first communication terminal according to Exemplary Embodiment 3.

FIG. 10 is a schematic block diagram of the communication system according to Exemplary Embodiment 5.

FIG. 11 is a configuration diagram of a charging system that uses the communication system according to Embodiment 5.

FIG. 12 is a perspective view of a main part of an example of the installed first communication terminal according to Embodiment 5.

FIG. 13A is a perspective view of a main part of the electrode according to Embodiment 5 for illustrating an installation process thereof.

FIG. 13B is a perspective view of the main part of an installed electrode according to Embodiment 5.

FIG. 13C is a perspective view of charging cable which is a supply line according to Embodiment 5.

FIG. 13D is a perspective view of a main part of an example of another installed first communication terminal according to Embodiment 5.

FIG. 14A is a perspective view of a main part of the electrode according to Embodiment 5 for illustrating an installation process thereof.

FIG. 14B is a perspective view of a main part of the installed electrode according to Embodiment 5.

FIG. 15A is a cross-sectional view of a main part of an example of the electrode according to Embodiment 5.

FIG. 15B is an enlarged sectional view of the electrode illustrated in FIG. 15A.

FIG. 16A is a perspective view of a main part of a ground terminal according to Embodiment 5 for illustrating a connection process thereof.

FIG. 16B is a perspective view of a main part of a connected ground terminal according to Embodiment 5.

FIG. 17A is a perspective view of a main part of an example of an installed second communication terminal according to Embodiment 5.

FIG. 17B is a perspective view of a main part of an example of the installed second communication terminal according to Embodiment 5.

FIG. 18 is a perspective view of a main part of an example of an installed first communication terminal according to Exemplary Embodiment 6.

FIG. 19 is a perspective view of a main part of an example of an installed first communication terminal according to Exemplary Embodiment 7.

FIG. 20 is a plan view of an electric vehicle and a charging apparatus that use a communication system according to Exemplary Embodiment 9.

FIG. 21 is a schematic block diagram of a communication system according to Exemplary Embodiment 10.

### DETAIL DESCRIPTION OF PREFERRED EMBODIMENTS

### Exemplary Embodiment 1

In the following exemplary embodiments, an electrode-attached communication terminal, communication terminal, communication system, electric vehicle, and charging apparatus which are used for a charging system of an electric vehicle equipped with a secondary battery as one example will be described. An outline of the charging system will be described below.

### <Outline of Charging System>

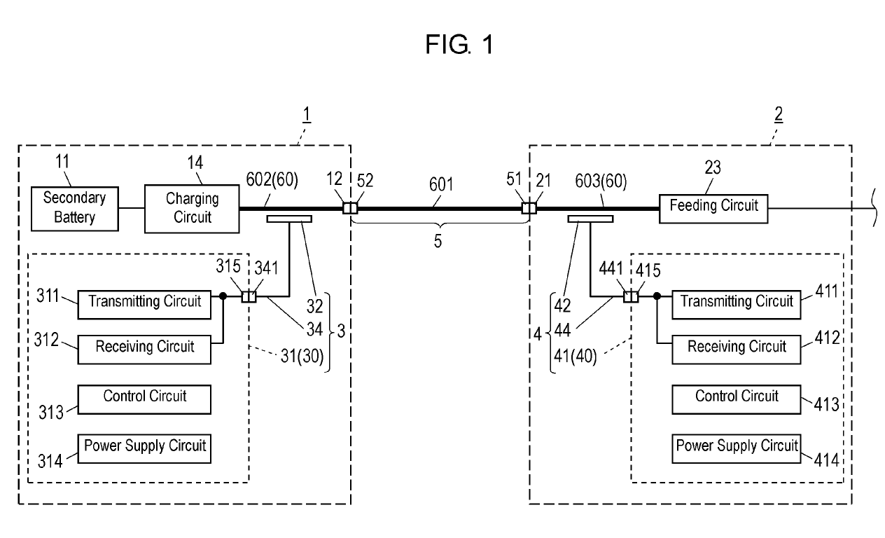

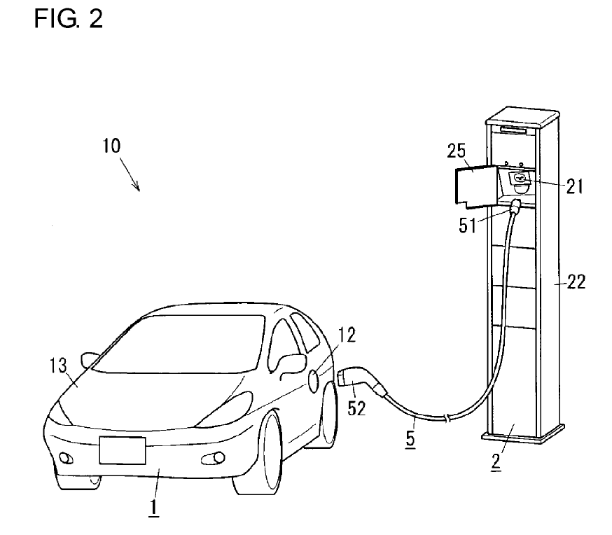

FIG. 1 is a schematic block diagram of a communication system according to Exemplary Embodiment 1. FIG. 2 is a schematic diagram of charging system 10 that uses the communication system according to Embodiment 1. Charging system 10 includes electric vehicle 1 and charging apparatus 2, as illustrated in FIG. 2.

In accordance with the present embodiment, charging apparatus 2 charges secondary battery 11 installed to electric vehicle 1 (shown in FIG. 1) by supplying, to electric vehicle 1, electric power supplied via a power line from commercial power source (system power source) or a power generating facility, such as a photovoltaic power generating facility. While the electric power to be supplied to charging apparatus 2 from the commercial power source or power generating facility may be either one of alternating current power and direct current power, the following describes a case of alternating current power as an example. The electric power to be supplied from charging apparatus 2 to electric vehicle 1 may also be either one of alternating current power and direct current power. The following describes a case of alternating current power as an example.

According to the embodiment, charging apparatus 2 is, for example, a charging stand installed on a ground in a parking lot of a commercial establishment, a public facility, or a collective housing. Charging apparatus 2 includes charging plug socket 21 (outlet) to which charging cable 5 as a supply line is to be electrically connected. Charging plug socket 21 is configured to allow plug 51 of charging cable 5 to be detachably connected thereto. Charging plug socket 21 is electrically connected to feeding circuit 23 accommodated in housing 22 of charging apparatus 2 (shown in FIG. 1). Accordingly, while charging cable 5 is connected to charging plug socket 21, charging apparatus 2 supplies electric power from feeding circuit 23 via charging cable 5 to electric vehicle 1.

Electric vehicle 1 has secondary battery 11 installed thereto. Battery 11 is charged with charging apparatus 2. Electric vehicle 1 runs using electric energy stored in secondary battery 11. While the following describes an electric-powered vehicle (EV) that runs using output of a motor as an example of electric vehicle 1, electric vehicle 1 is not limited to the electric-powered vehicle. Electric vehicle 1 may be, for example, a plug-in hybrid vehicle (PHEW) that runs by combining engine output and motor output, a two-wheel vehicle (an electric motorcycle), a tricycle, or a power-assisted bicycle.

Electric vehicle 1 includes charging inlet 12 to which connector 52 of charging cable 5 is to be electrically connected. Charging inlet 12 is configured to allow connector 52 of charging cable 5 to be detachably connected thereto. Charging inlet 12 is electrically connected to charging circuit 14 (refer to FIG. 1) accommodated in car body 13 of electric vehicle 1. Accordingly, while charging cable 5 is connected to charging inlet 12, electric vehicle 1 receives electric power from charging apparatus 2 via charging cable 5, and charges secondary battery 11 by charging circuit 14.

Charging system 10 may have any configuration to exchange electric power (electric energy) as a resource between charging apparatus 2 and electric vehicle 1, and charging system 10 is not limited to the configuration to perform only charging of secondary battery 11. That is, charging system 10 may be configured to discharge secondary battery 11. In this case, charging system 10 can perform V2G (Vehicle to Grid), for example, by supplying electric power of secondary battery 11 from charging apparatus 2 to a distribution network.

In charging system 10 described above, an authentication process of electric vehicle 1 may be performed, for example, in order to perform billing according to an amount of charging, or in order to determine whether electric vehicle 1 is a vehicle to which charging is permitted or not. These applications require a communication between electric vehicle 1 and charging apparatus 2. Therefore, in accordance with the following embodiments, the electrode-attached communication terminal, communication terminal, and communication system which are used for the communication between electric vehicle 1, which is a first device, and charging apparatus 2, which is a second device, in charging system 10 will be described.

Although the configuration of the electrode-attached communication terminal as first communication terminal 3 as an example in accordance with the present embodiment will be described, an electrode-attached communication terminal with a configuration identical to the configuration of first communication terminal 3 is also used as second communication terminal 4. Therefore, unless otherwise specified, the following describes the electrode-attached communication terminal as first communication terminal 3 (also referred to as “electrode-attached communication terminal 3”), and the description of the electrode-attached communication terminal as second communication terminal 4 (also referred to as “electrode-attached communication terminal 4”) is omitted.

As illustrated in FIG. 1, electrode-attached communication terminal 3 according to the present embodiment includes communication unit 31 and electrode 32.

Communication unit 31 is provided in the first device (electric vehicle 1), and is configured to communicate with a destination terminal (second communication terminal 4). The destination terminal is provided in the second device (charging apparatus 2) that exchanges a resource with the first device through the supply line (charging cable 5). Electrode 32 is disposed with a space from conductive member 60 so as to be coupled via electric field to conductive member 60. Conductive member 60 includes at least one of first conductor 601 included in the supply line (charging cable 5) and second conductor 602 electrically connected to first conductor 601. Communication unit 31 is electrically connected to electrode 32, and is configured to communicate with the destination terminal by using a signal transmitted via conductive member 60 as a medium.

In electrode-attached communication terminal 3, electrode 32 is electrically coupled to conductive member 60 while not contacting conductive member 60 by being coupled via electric field to conductive member 60. A signal is exchanged with the destination terminal via by using conductive member 60 as a medium to allow electrode-attached communication terminal 3 to perform electric field communication with the destination terminal. The electric field communication is a communication in which a predetermined signal propagates through a particular communication path (conductive member 60) mainly by using a static electrostatic field or a quasi-electrostatic field. For example, the electric field communication is communication that transmits a predetermined signal by using an electric field that occurs between conductive member 60 and the ground. Components of an electric field (static electrostatic field or quasi-electrostatic field) at a position attenuate in proportion to the third power of the distance from the position to electrode 32 when propagating through space. That is, the electric field used by the electric field communication mentioned here depends on the distance from electrode 32, and rapidly attenuates when the distance increases. Unlike radiated waves of wireless communication, the signal transmitted by this electric field communication does not propagate through a space with little attenuation. This electric field communication establishes communication between terminals connected through a particular communication path instead of an unspecified path in space. Also, in the electric field communication mentioned here, since attenuation of the electric field while propagating through conductive member 60 is smaller than a case of propagating through space, communication can be established with very small energy although non-contact, compared with wireless communication using radiated waves.

Conductive member 60 is preferably made of metal. Although communication can be established even if conductive member 60 is made of conductive resin, such as, conductive polymer since metal generally has higher conductivity than conductive resin, conductive member 60 made of metal can reduce a loss in the communication path. Also, for example, although communication can be established even if a medium that is mainly made of water is used as conductive member 60, such as a human body, water hose, and piping for water, this medium can lead to large loss in the communication path in a similar manner to the conductive resin.

Furthermore, such a medium mainly made of water does not have a stable shape, and for example, substantial electrical conductivity of a human body will change depending on posture thereof or the like. Therefore, conductive member 60 made of metal is more preferable to communication stability.

In the case that a line, such as a neutral line and a protective grounding conductor, that can have a potential identical to the potential of the ground is provided together with conductive member 60, for example, the neutral line can be used as a part of an end of an electric force line by grounding the neutral line with low impedance. This configuration provides plural electric field ends, thereby improving communication quality against an obstacle that blocks the electric field. In this case, the ground of communication unit 31 is connected to the neutral line to provide more stable communication.

In accordance with the present embodiment, as an example, the first device is electric vehicle 1, the second device is charging apparatus 2, the supply line is charging cable 5, and the resource is electric power (electric energy). In accordance with the present embodiment, for first communication terminal 3 provided in electric vehicle 1, second communication terminal 4 is the destination terminal, and first communication terminal 3 communicates with second communication terminal 4. In contrast, for second communication terminal 4 provided in charging apparatus 2, first communication terminal 3 is the destination terminal, and second communication terminal 4 communicates with first communication terminal 3.

The electrode-attached communication terminal according to the present embodiment will be detailed below. However, the configuration to be described below is only one example of the present invention, the present invention is not limited to the following exemplary embodiment, and various changes according to design or the like can be made even other than this exemplary embodiment without departing from technical ideas according to the present invention.

### <Configuration of the Electrode-Attached Communication Terminal>

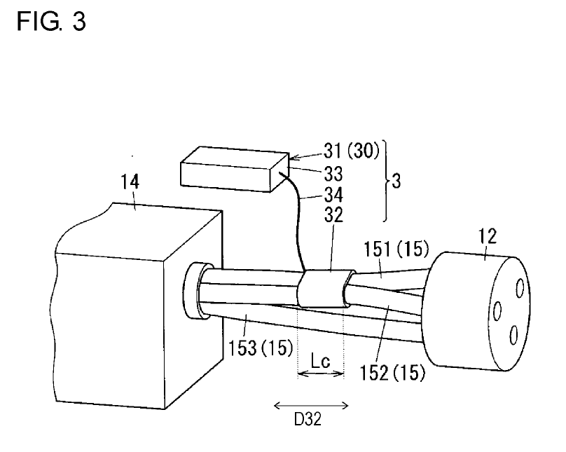

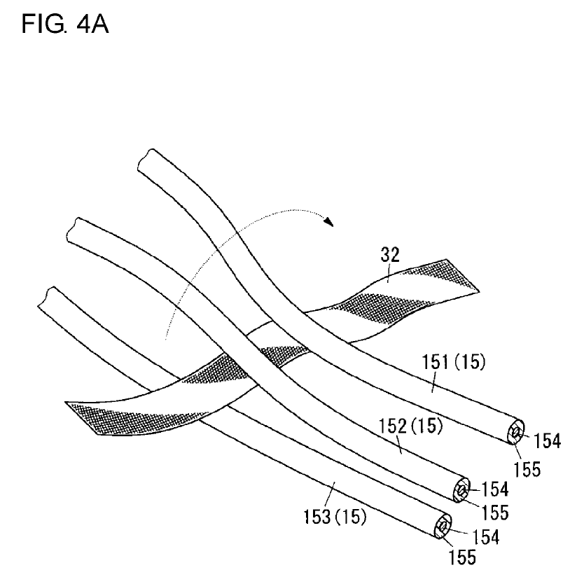

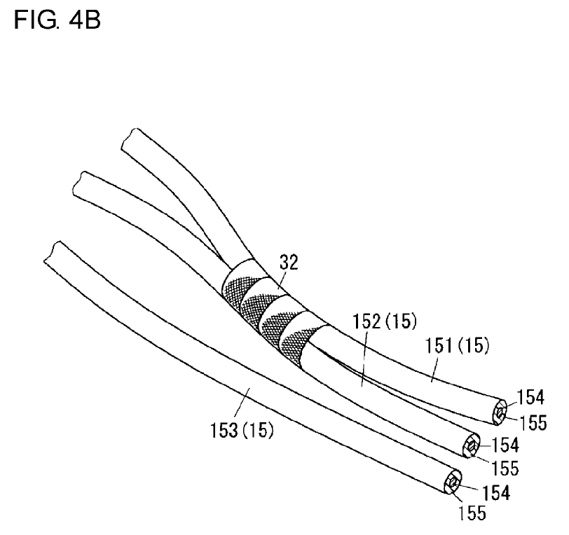

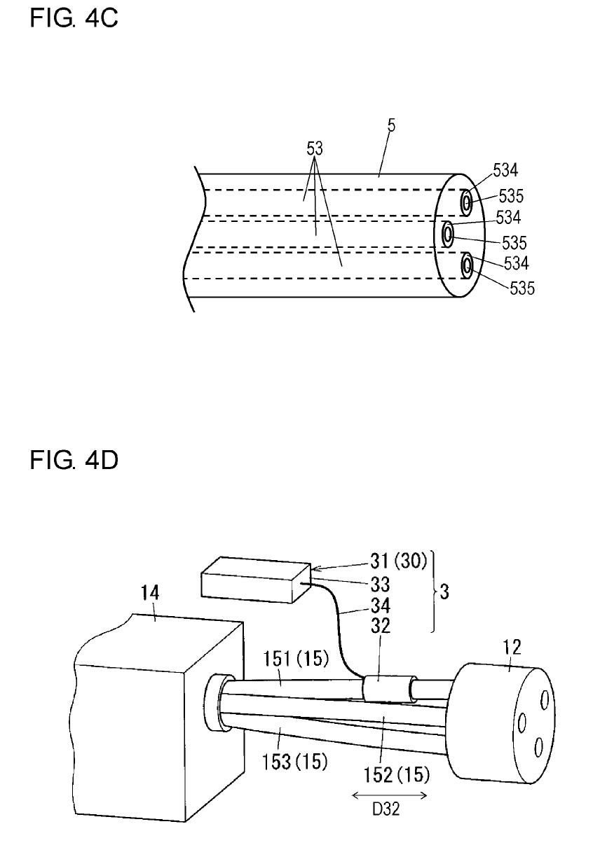

FIG. 3 is a perspective view of installed first communication terminal 3 according to Embodiment 1. FIG. 4A and FIG. 4B are perspective views of main parts of electrode 32 for illustrating an installation process thereof. In addition to communication unit 31 and electrode 32 described above, electrode-attached communication terminal 3 according to the present embodiment further includes case 33 that is an enclosure of communication unit 31 (refer to FIG. 3), and cable 34 that connects communication unit 31 and electrode 32.

Electrode 32 is electrically connected to communication unit 31 via cable 34. Since electrode-attached communication terminal 3 of the present embodiment performs electric field communication while electrode 32 is electrically coupled to conductive member 60 while not contacting conductive member 60, electrode 32 does not directly contact conductive member 60.

FIG. 4C is a perspective view of charging cable 5 which is the supply line in accordance with Embodiment 1. Since the supply line is charging cable 5 of the present embodiment, first conductor 601 included in the supply line includes core wire 534 of electric wire 53 included in charging cable 5. Second conductor 602 electrically connected to first conductor 601 includes core wire 154 (refer to FIG. 4A) of internal wire 15 (refer to FIG. 3) that electrically connect charging inlet 12 and charging circuit 14 in the first device (electric vehicle 1). Each of these electric wires (electric wire 53 and internal wire 15) is, for example, a vinyl insulated wire in which a copper core wire is covered with a sheath made of, e.g. vinyl. Electrode 32 is disposed with a space from conductive member 60 including at least one of first conductor 601 and second conductor 602 as described above, thereby being coupled via electric field to conductive member 60. In accordance with the present embodiment, conductive member 60 includes second conductor 602 while electrode 32 is coupled via electric field to second conductor 602.

Here, in accordance with the present embodiment, electrode 32 is configured to be coupled via electric field to conductive member 60 by being capacitively coupled to conductive member 60. Here, a capacitance component formed between electrode 32 and conductive member 60 (hereinafter referred to as “coupling capacitance”) is determined by a distance from electrode 32 to conductive member 60 and a dielectric constant of a substance that lies between electrode 32 and conductive member 60. A space large enough to form a coupling capacitance may be provided between electrode 32 and conductive member 60. It is not essential that sheath 155 lies between electrode 32 and conductive member 60, and that, for example, a gap (space) may exist between electrode 32 and conductive member 60.

Electrode 32 coupled via electric field to conductive member 60 by capacitive coupling can reduce a coupling loss between electrode 32 and conductive member 60. Although electric field coupling between electrode 32 and conductive member 60 can also be performed, for example, by disposing electrode 32 including a wire to be entwined conductive member 60, such electric field coupling causes a larger coupling loss than capacitive coupling. In capacitive coupling, since electrode 32 faces a surface of conductive member 60 in parallel, the coupling loss between electrode 32 and conductive member 60 can be reduced.

As detailed later, electrode 32 is preferably made of a conductive sheet. Electrode 32 is more preferably made of, e.g. a metal mesh sheet, a metal foil, or a metal tape.

As illustrated in FIG. 1, communication unit 31 includes transmitting circuit 311, receiving circuit 312, control circuit 313, and power supply circuit 314. Transmitting circuit 311, receiving circuit 312, control circuit 313, and power supply circuit 314 are disposed inside case 33.

Transmitting circuit 311 is electrically connected to electrode 32, and is configured to generate a transmission signal that contains information by modulating a carrier wave (carrier) and to apply the transmission signal to electrode 32. Transmitting circuit 311 uses, for example, a rectangular wave having a frequency of about 10 [MHz] as the carrier wave, and employs On Off Keying (OOK) as a modulation method. When transmitting circuit 311 applies the transmission signal to electrode 32, an electric field (quasi-electrostatic field) is induced in conductive member 60 coupled via electric field to electrode 32. The electric field induced in conductive member 60 propagates through conductive member 60 with a little attenuation, and then, reaches the second device (charging apparatus 2). Receiving circuit 412 of the destination terminal (second communication terminal 4) provided in the second device thus receives the transmission signal.

Receiving circuit 312 is electrically connected to electrode 32, and is configured to receive the transmission signal from the destination terminal. Receiving circuit 312 receives the transmission signal induced in electrode 32 by the electric field generated in conductive member 60 coupled via electric field to electrode 32. Then, receiving circuit 312 demodulates the transmission signal to extract information contained in the transmission signal.

Control circuit 313 mainly includes a micro processing unit (MPU) configured to control transmitting circuit 311 and receiving circuit 312. This configuration enables communication unit 31 to communicate with the destination terminal (second communication terminal 4) by using the signal transmitted via conductive member 60 as a medium. Communication unit 31 including both transmitting circuit 311 and receiving circuit 312 can exchange the transmission signal, and can perform bidirectional communication with the destination terminal.

Power supply circuit 314 is configured to supply electric power for operations to transmitting circuit 311, receiving circuit 312, and control circuit 313. Power supply circuit 314 includes, for example, a primary battery as a power supply, and supplies electric power of the primary battery to the circuits.

Communication unit 31 is configured to communicate with the destination terminal while the first device is connected to the second device via the supply line. Communication unit 31 is configured not to communicate with the destination terminal while the first device is connected to the second device via the supply line. In accordance with the embodiment, as described above, the first device is electric vehicle 1, the second device is charging apparatus 2, and the supply line is charging cable 5. Second communication terminal 4 is the destination terminal for first communication terminal 3 provided in electric vehicle 1. Therefore, communication unit 31 of first communication terminal 3 communicates with second communication terminal 4 while electric vehicle 1 is connected to charging apparatus 2 via charging cable 5. Communication unit 31 does not communicate with second communication terminal 4 while electric vehicle 1 is not connected to charging apparatus 2 via charging cable 5. Whether or not electric vehicle 1 is connected to charging apparatus 2 via charging cable 5 is determined based on a detection result of a connection detector that detects a connection status of plug 51 of charging cable 5 to charging plug socket 21.

When the connection detector detects that plug 51 is connected to charging plug socket 21, communication unit 31 determines that the first device is connected to the second device via the supply line, and then, communication unit 31 communicates with second communication terminal 4 which is the destination terminal. On the other hand, when the connection detector detects that the connection between plug 51 and charging plug socket 21 is canceled, communication unit 31 determines that the first device is not connected to the second device via the supply line, and then, does not communicate with second communication terminal 4 which is the destination terminal. The connection detector may be included in communication unit 31, but may be provided separately from communication unit 31. The connection detector is configured to detect the connection status of plug 51 of charging cable 5 to charging plug socket 21 optically, for example, by using reflection of infrared light or the like, or to detect the connection status electrically based on an electric power application state. Instead of the connection status of plug 51 to charging plug socket 21, the connection detector may detect the connection status of connector 52 of charging cable 5 to charging inlet 12.

That is, first communication terminal 3 and second communication terminal 4 mainly use an electric field component that attenuates in proportion to the third power of a distance from electrode 32 when propagating through space, and performs communication by electric field communication by which a predetermined signal propagates through a particular communication path (conductive member 60). Accordingly, even when electric vehicle 1 is not connected to charging apparatus 2 via charging cable 5, first communication terminal 3 and second communication terminal 4 can be in a communicative status, e.g, when plug 51 of charging cable 5 exists near charging plug socket 21. By communicating with the destination terminal only when the first device is connected to the second device via the supply line as described above, communication unit 31 can communicate only when being connected via a wire similarly to a wired communication although non-contact.

### <Configuration of Communication Terminal>

Communication unit 31 of electrode-attached communication terminal 3 with the above-described configuration constitutes communication terminal 30 without electrode 32. That is, communication terminal 30 according to the embodiment includes communication unit 31. Communication unit 31 includes connection terminal 315 electrically connected to electrode 32. Connector 341 provided at an end of cable 34 opposite to electrode 32 is detachably connected to connection terminal 315. That is, while connector 341 is connected to connection terminal 315, connection terminal 315 is electrically connected to electrode 32 via cable 34. Connection terminal 315 is exposed from a part of case 33.

Communication terminal 30 thus configured constitutes electrode-attached communication terminal 3 described above together with electrode 32 by connecting electrode 32 to connection terminal 315. Therefore, when plural types of electrode 32 are available, communication terminal 30 can be connection with arbitrary electrode 32 out of the plural of types of electrode 32.

### <Configuration of Electrode>

A configuration of electrode 32 will be described below.

In accordance with the embodiment, electrode 32 is a conductive sheet. Since electrode 32 is made of conductive material, electrode 32 can, for example, efficiently convert the transmission signal (electric power) output from transmitting circuit 311 into an electric field, and superimpose the converted transmission signal on first conductor 601 or second conductor 602 as the electric field. This is because the entire of electrode 32 made of conductive material is generally equipotential to generate almost no electric loss, allowing the transmission signal to be applied onto the entire of electrode 32 substantially uniformly without a loss. This configuration reduces a loss of the transmission signal in a communication path, such as a path from transmitting circuit 311 to receiving circuit 412 of the destination terminal (second communication terminal 4). Communication unit 31 can thus reduce electric power necessary for communication. In particular, when communication unit 31 is power by a battery, this configuration prolongs the battery life and the battery replacement cycle.

Electrode 32 may be made of non-conductive material (electrically insulating material), such as synthetic resin. Even in this case, electrode 32 can be coupled via electric field to conductive member 60. However, in electrode 32 made of electrically insulating material, a potential on a surface of electrode 32 becomes non-uniform, and the electric loss on the surface of electrode 32 is larger than electrode 32 made of conductive material, which may cause a larger transmission loss.

Electrode 32 is coupled via electric field to second conductor 602 by being wound around internal wire 15, as illustrated in FIG. 3. Electrode 32 is wound around internal wire 15 on sheath 155 (refer to FIG. 4A).

In other words, with respect to internal wire 15 having the structure in which second conductor 602 composed of core wire 154 is covered with sheath 155, electrode 32 is disposed as to face second conductor 602 across sheath 155 without breaking sheath 155. Therefore, a distance from electrode 32 to second conductor 602 is generally identical to the thickness of sheath 155. Thus, electrode 32 which is disposed with a space of the thickness of sheath 155 from conductive member 60 (second conductor 602), is capacitively coupled (electric field coupling) to conductive member 60.

In accordance with the embodiment, electrode 32 surrounds conductive member 60 in an entire circumference of a circumferential direction of conductive member 60. That is, in the case that conductive member 60 (second conductor 602) is composed of core wire 154 of internal wire 15, electrode 32 surrounds conductive member 60 in the entire circumference of the circumferential direction in a cross-section perpendicular to an extending direction (lengthwise direction) of internal wire 15. This configuration ensures the facing area of electrode 32 facing conductive member 60 as large as possible, and reduces the transmission loss. That is, when the facing area of electrode 32 facing conductive member 60 increases, a coupling capacitance between electrode 32 and conductive member 60 increases, accordingly decreasing the transmission loss. Note that methods for reducing the transmission loss (coupling loss) in a coupling section between electrode 32 and conductive member 60 include a method for matching impedance in addition to the above-described method. For example, impedance of communication terminal 30 (communication unit 31) from electrode 32 is determined to be matched with impedance of electrode 32 from communication terminal 30 at a frequency of the carrier wave of the transmission signal, thereby decreasing the coupling loss. As in the present exemplary embodiment, in the case where the frequency of the carrier wave is about 10 [MHz], when the impedance of communication terminal 30 from electrode 32 is similar to the impedance of electrode 32 from communication terminal 30 at about 10 [MHz], which is the frequency of the carrier wave, the coupling loss can be reduced.

Electrode 32 may not necessarily surround conductive member 60 in the entire circumference of the circumferential direction of conductive member 60. Electrode 32 may surround conductive member 60 except for a part of conductive member 60 in the circumferential direction of conductive member 60. Even in the case where there is no space around internal wire 15 to wind electrode 32 in the entire circumference of the circumferential direction of internal wire 15, electrode 32 can be coupled via electric field to conductive member 60.

In accordance with the embodiment, a wiring between charging apparatus 2 and electric vehicle 1 is single-phase three-wire system 100V wiring. That is, as illustrated in FIG. 3, internal wire 15 as conductive member 60 includes neutral line 153 of N phase and a pair of voltage lines 151 and 152 of L1 phase and L2 phase. Neutral line 153 is electrically connected, for example, to a stable potential point, such as the ground, via charging cable 5 of charging apparatus 2. That is, neutral line 153 is grounded. This configuration causes a voltage of neutral line 153 with respect to the ground to become 0 [v], and causes a voltage of each of the pair of voltage lines 151 and 152 with respect to the ground to become 100 [v]. The voltage between one voltage line 151 (L1 phase) and neutral line 153 (N phase) becomes 100 [v], the voltage between another voltage line 152 (L2 phase) and neutral line 153 (N phase) becomes 100 [v]. The voltage between the pair of voltage lines 151, 152 becomes 200 [V].

That is, the resource is electric power. Conductive member 60 includes neutral line 153 and voltage lines 151 and 152. Electrode 32 is configured to be coupled via electric field only to voltage lines 151 and 152 out of neutral line 153 and voltage lines 151 and 152. In the configuration shown in FIG. 3, as the pair of voltage lines 151 and 152 is bundled with electrode 32, electrode 32 is wound around two of three internal wires 15 (both voltage lines 151 and 152).

FIG. 4D is a perspective view of a main part of another installation status of the first communication terminal according to Embodiment 1. In FIG. 4D, components identical to those of the first terminal illustrated in FIG. 3 are denoted by the same reference numerals. In the example shown in FIG. 4D, electrode 32 is wound only around one voltage line 151 out of the pair of voltage lines 151 and 152 while electrode 32 is not wound around voltage line 152. In the example shown in FIG. 4D, electrode 32 is wound so as to closely adhere to sheath 155 with almost no gap.

Electrode 32 is preferably coupled via electric field only to voltage lines 151 and 152 out of conductive member 60 excluding neutral line 153. That is, in the electric field communication, since signals are transmitted using an electric field generated between conductive member 60 and a reference potential point, neutral line 153 which can be the reference potential point is preferably not included in conductive member 60. Electrode 32 may be coupled via electric field to both of the pair of voltage lines 151 and 152 as illustrated in FIG. 3, and may be coupled via electric field only to one of the pair of voltage lines 151 and 152 as illustrated in FIG. 4D. In comparison of these configurations, the signal reception strength is higher in the configuration shown in FIG. 3 (electrode 32 is coupled via electric field to both of the pair of voltage lines 151 and 152) than the configuration shown in FIG. 4D (electrode 32 is coupled via electric field to one of the pair of voltage lines 151 and 152).

In the examples shown in FIG. 4A and FIG. 4B, electrode 32 is a mesh sheet having a strip shape, and is wound around internal wire 15 plural turns around internal wire 15. In this configuration, electrode 32 preferably has a configuration in which an adhesive is coated on one surface in terms of workability. In this configuration, electrode 32 is relatively thin and easy to wind, and thus it is easy to wind electrode 32 around relatively thin (with a small diameter) internal wire 15 so as to cause electrode 32 to adhere securely thereto.

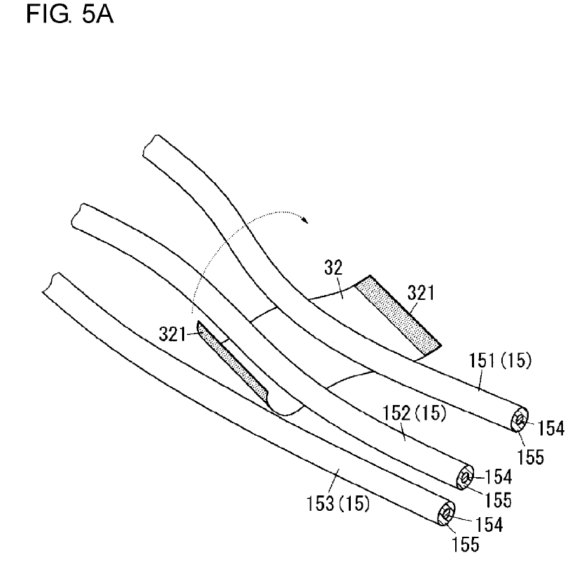

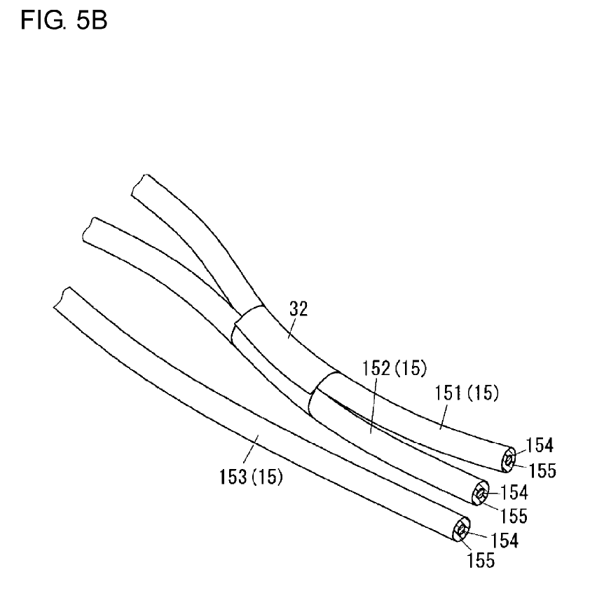

FIG. 5A and FIG. 5B are perspective views of a main part of still another installment process of electrode 32 according to Embodiment 1. In the examples shown in FIG. 5A and FIG. 5B, hook-and-loop fastener 321 is provided on both sides of electrode 32. In this configuration, electrode 32 is wound around internal wire 15 and fixed with hook-and-loop fastener 321 on both sides of electrode 32 while being rolled around internal wire 15. Since electrode 32 is detachable in this configuration, electrode-attached communication terminal 3 including electrode 32 can be easily removed from internal wire 15 at a time of, e.g. maintenance of electrode-attached communication terminal 3.

Electrode 32 is preferably made of a mesh metal sheet, a metal foil, a metal tape, or the like as described above. This configuration allows electrode 32 to closely adhere to the surface of internal wire 15 easily, and reduces the transmission loss. In particular, the mesh metal sheet more preferably adheres to the surface of internal wire 15 than the metal foil or the metal tape. The mesh metal sheet can be wound around internal wire 15 with almost no air layer that lies between internal wire 15 and the metal sheet. In short, magnitude of a coupling capacitance between electrode 32 and conductive member 60 is determined by a distance from electrode 32 to conductive member 60 and a dielectric constant of the substance that lies between electrode 32 and conductive member 60. The transmission loss decreases as the coupling capacitance increases. Therefore, electrode 32 securely adhering to internal wire 15 reduces the distance from electrode 32 to conductive member 60, and prevents an air layer from lying between electrode 32 and conductive member 60, thereby providing a large coupling capacitance and a small transmission loss.

In the case that electrode 32 has a mesh structure, internal wire 15 is exposed from meshes of electrode 32, hence not being covered with electrode 32 completely. However, when a high-frequency transmission signal with the carrier wave having a frequency equal to or higher than several megahertz is used for communication, electrode 32 failing to cover internal wire 15 completely does not much affect the transmission loss.

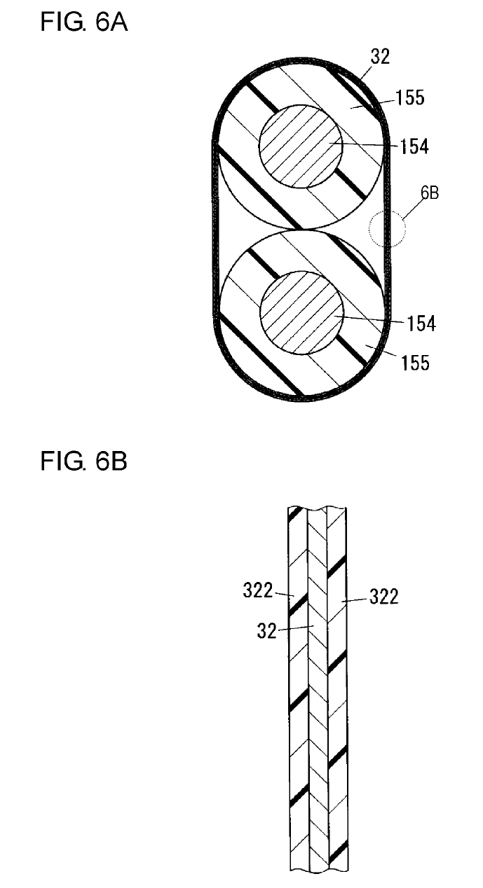

FIG. 6A is a cross-sectional view of a main part of another example of electrode 32 according to Embodiment 1. FIG. 6B is an enlarged sectional view of section 6B of electrode 32 illustrated in FIG. 6A. Electrode-attached communication terminal 3 may further include electrical insulator 322 that covers electrode 32 as illustrated in FIG. 6A and FIG. 6B. In the examples shown in FIG. 6A and FIG. 6B, electrical insulator 322 made of sheath material made of synthetic resin covers both sides of electrode 32. Electrical insulator 322 is formed, for example, by coating electrode 32 with the resin or winding a tape with electrical insulation properties around electrode 32. This structure prevents electrode 32 from directly contacting a metal conductor around internal wire 15. Since electrode 32 is protected by electrical insulator 322, even when electrode 32 is made of copper or other materials, aged deterioration of electrode 32 caused by rust or the like is inhibited, resulting in that low transmission loss can be maintained over long periods. For purposes of rust prevention of electrode 32, electrical insulator 322 preferably has a water shielding property so as to prevent water from attaching to electrode 32. Electrical insulator 322 may be provided only on one side of electrode 32. In this case, electrode 32 is wound around internal wire 15 with a surface of electrical insulator 322 being outside, and electrode 32 is not exposed from electrical insulator 322.

In the case that conductive member 60 has a linear shape or a tubular shape extending in extending direction D32, the length of electrode 32 in extending direction D32 of conductive member 60 is preferably smaller than ¼ of a wavelength of the above-described signal. In the following, the length of electrode 32 in extending direction D32 of conductive member 60 is referred to as coupling length Lc of electrode 32 (refer to FIG. 3). When the signal used in electrode-attached communication terminal 3 for communication has a wavelength λ [m], coupling length Lc of electrode 32 is preferably less than λ/4 [m]. The signal wavelength λ mentioned here is a wavelength of the carrier wave (carrier) of the transmission signal. For example, when transmitting circuit 311 transmits the signal (transmission signal) by using the carrier wave of 10 [MHz] as described above, the signal wavelength λ is 30 [m]. In this case, coupling length Lc of electrode 32 is preferably less than 7.5 [m] (=30/4 hp. In this structure, electrode 32 is unlikely to function as an antenna for an electromagnetic wave of wavelength λ identical to the wavelength of the transmission signal, and electrode 32 is less susceptible to electromagnetic waves.

### <Method for Installing the Electrode-Attached Communication Terminal>

When installing electrode-attached communication terminal 3, an operator fixes communication unit 31 of electrode-attached communication terminal 3 to a predetermined position of electric vehicle 1 (first device), and causes electrode 32 to be coupled via electric field to conductive member 60. At this moment, the operator can cause electrode 32 to be coupled via electric field to conductive member 60 by winding electrode 32 on sheath 155 around internal wire 15.

The operator fixes communication unit 31 by fixing case 33 together with a bolt near charging inlet 12 on the car body of electric vehicle 1. The fixing position to fix communication unit 31 in electric vehicle 1 is determined according to a length of cable 34 as to allow cable 34 to connect communication unit 31 to electrode 32. In the case that communication unit 31 includes a primary battery as a power supply in power supply circuit 314, the operator does not necessarily connect an external power source to communication unit 31 as to secure electric power for operations of communication unit 31.

Thus, when installing electrode-attached communication terminal 3 according to the embodiment in electric vehicle 1, the operator does not necessarily connect electrode-attached communication terminal 3 electrically to an electric system of electric vehicle 1, and electrode-attached communication terminal 3 can be installed by relatively simple work without involving processing of the electric system of electric vehicle 1. Therefore, when electric vehicle 1 as the first device has a space only for installing electrode-attached communication terminal 3, electrode-attached communication terminal 3 can be easily installed to electric vehicle 1 as the first device after the electric vehicle is completed.

### <Configuration of Second Communication Terminal>

In accordance with the embodiment, as described above, first communication terminal 3 provided in the first device has the same configuration as second communication terminal 4 provided in the second device. Therefore, the description of electrode-attached communication terminal 3 described above as first communication terminal 3 becomes the description of electrode-attached communication terminal 4 as second communication terminal 4 by interpreting the first device (electric vehicle 1) as the second device (charging apparatus 2). Here, communication unit 31 (communication terminal 30), electrode 32, case 33, and cable 34 of first communication terminal 3 correspond to communication unit 41 (communication terminal 40), electrode 42, case 43, and cable 44 of second communication terminal 4, respectively. Transmitting circuit 311, receiving circuit 312, control circuit 313, power supply circuit 314, connection terminal 315, and connector 341 correspond to transmitting circuit 411, receiving circuit 412, control circuit 413, power supply circuit 414, connection terminal 415, and connector 441, respectively.

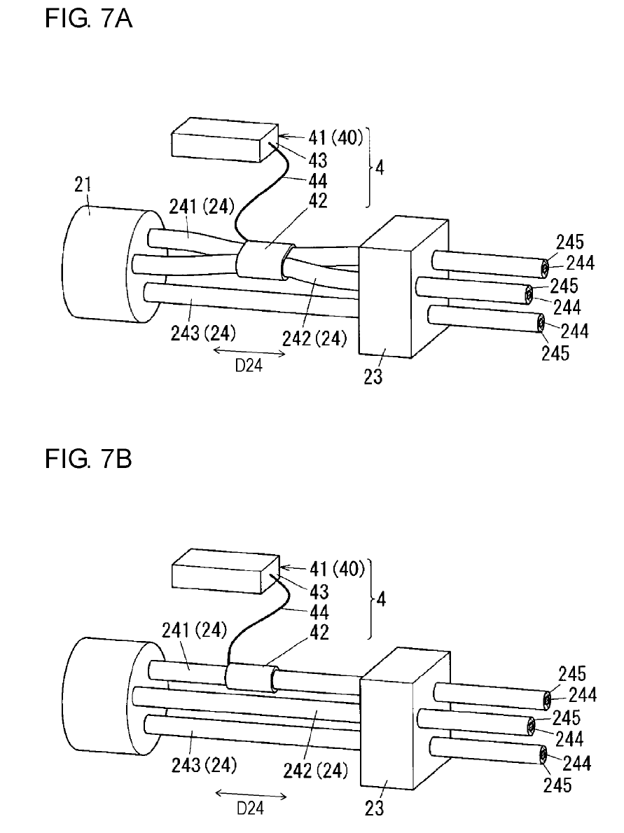

FIG. 7A is a perspective view of a main part of one example of the installed state of the second communication terminal according to Embodiment 1. FIG. 7B is a perspective view of the main part illustrating one example of another installed state of the second communication terminal according to Embodiment 1. In the second device (charging apparatus 2), second conductor 603 electrically connected to first conductor 601 includes core wire 244 (refer to FIG. 7A) of internal wire 24 (refer to FIG. 7A) that electrically connects between charging plug socket 21 and feeding circuits 23 in the second device. Therefore, electrode 42 of electrode-attached communication terminal 4 is coupled via electric field to second conductor 603 by being wound around internal wire 24, as illustrated in FIG. 7A and FIG. 7B. Electrode 42 is wound on sheath 245 around internal wire 24 over sheath 245.

In accordance with the embodiment, electrode 42 surrounds the conductive member in an entire circumference of a circumferential direction of conductive member 60. That is, in the case that conductive member 60 (second conductor 603) includes core wire 244 of internal wire 24, electrode 42 surrounds conductive member 60 in the entire circumference of the circumferential direction in a cross-section of internal wire 24 perpendicular to extending direction D24 (lengthwise direction) of internal wire 24.

In accordance with the embodiment, since a wiring between charging apparatus 2 and electric vehicle 1 is single-phase three-wire system 100V wiring, as illustrated in FIG. 7A, internal wire 24 as conductive member 60 includes neutral line 243 of N phase and a pair of voltage lines 241 and 242 of L1 phase and L2 phase. Neutral line 243 is electrically connected, for example, to a stable potential point, such as the ground. That is, neutral line 243 is grounded. Accordingly, a voltage of neutral line 243 with respect to the ground which is a voltage between neutral line 243 and the stable potential point becomes 0 [V], whereas a voltage of each of voltage lines 241 and 242 with respect to the ground which is a voltage between the stable potential point and each of the pair of voltage lines 241 and 242 becomes 100 [V]. The voltage between one voltage line 241 (L1 phase) and neutral line 243 (N phase) becomes 100 [V]. The voltage between another voltage line 242 (L2 phase) and neutral line 243 (N phase) becomes 100 [V]. The voltage between the pair of voltage lines 241, 242 becomes 200 [V].

That is, the resource is electric power. Conductive member 60 includes neutral line 243 and voltage lines 241 and 242. Electrode 42 is configured to be coupled via electric field only to voltage lines 241 and 242 out of neutral line 243 and voltage lines 241 and 242. Electrode 42 is not coupled via electric field to neutral line 243 substantially. In the example shown in FIG. 7A, electrode 42 is wound around two of three internal wires 24 (both voltage lines 241 and 242) to bundle the pair of voltage lines 241 and 242 with electrode 42. On the other hand, in the example shown in FIG. 7B, electrode 42 is wound only around one voltage line 241 out of the pair of voltage lines 241 and 242. In the example shown in FIG. 7B, electrode 42 is wound so as to adhere closely to sheath 245 with almost no gap.

Thus, electrode 42 is preferably coupled via electric field only to voltage lines 241 and 242 out of conductive member 60 excluding neutral line 243. That is, in the electric field communication, since signals are transmitted using the electric field that occurs between conductive member 60 and the reference potential point, neutral line 243 that can be the reference potential point is preferably not included in conductive member 60. Electrode 42 may be coupled via electric field to both of the pair of voltage lines 241 and 242 as illustrated in FIG. 7A, and may be coupled via electric field only to one voltage line of the pair of voltage lines 241 and 242, and may not be coupled via electric field to another voltage line, as illustrated in FIG. 7B. In comparison of these configurations, the signal reception strength is higher in the configuration shown in FIG. 7A (electrode 42 being coupled via electric field to both of the pair of voltage lines 241 and 242) than the configuration shown in FIG. 7B (electrode 42 being coupled via electric field to only one of the pair of voltage lines 241 and 242).

However, an aspect of the electric field coupling of electrodes 32 and 42 to conductive member 60 is preferably identical to each other between first communication terminal 3 and second communication terminal 4. That is, when electrode 32 of first communication terminal 3 is coupled via electric field to both of the pair of voltage lines 151 and 152 (refer to FIG. 3), electrode 42 of second communication terminal 4 is preferably coupled via electric field to both of the pair of voltage lines 241 and 242 (refer to FIG. 7A). Meanwhile, when electrode 32 of first communication terminal 3 is coupled via electric field to only one voltage line 151 (refer to FIG. 4D), electrode 42 of second communication terminal 4 is preferably coupled via electric field to only one voltage line 241 (refer to FIG. 7B). When electrodes 32 and 42 each being coupled via electric field to only one voltage line, the voltage line to which electrode 32 is coupled preferably has the sane phase as the voltage line to which electrode 42 is coupled, but may have different phases (L1 phase and L2 phase) from the voltage line to which electrode 42 is coupled.

Meanwhile, as a function peculiar to second communication terminal 4 provided in charging apparatus 2, which is the second device, second communication terminal 4 may have a function to control feeding circuit 23 of charging apparatus 2. In this case, for example, by turning on and off a relay provided in feeding circuit 23, second communication terminal 4 can switch whether or not electric power is supplied from charging apparatus 2 to electric vehicle 1 which is the first device. In accordance with the embodiment, second communication terminal 4 has a function to control feeding circuit 23 of charging apparatus 2.

### <Detail of Electrode-Attached Communication Terminals>

The electrode-attached communication terminals will be detailed below.

In accordance with the embodiment, the reference potential point of communication unit 41 of second communication terminal 4 is grounded. Specifically, the reference potential point of communication unit 41 which serves as a circuit ground in transmitting circuit 411 and receiving circuit 412 is grounded, for example, by being electrically connected to a body having a stable potential that can be a reference, such as the ground, with an electric conductor. Accordingly, communication unit 41 becomes stable because the potential of the reference potential point is identical to the potential of a stable potential point, such as the ground, providing a higher transmission efficiency than the case where the reference potential point is not grounded. In other words, since first communication terminal 3 and second communication terminal 4 transmit the transmission signal, for example, by using the electric field that occurs between conductive member 60 and the ground as described above, the stable reference potential point of communication unit 41 reduces the transmission loss and improves the transmission efficiency. The stable reference potential point of communication unit 41 reduces spurious emission.

In accordance with the embodiment, the reference potential point of communication unit 41 is grounded via a frame ground of charging apparatus 2. That is, housing 22 of charging apparatus 2 is made of conductive metal. The reference potential point of feeding circuit 23 is electrically connected to housing 22. The reference potential point of communication unit 41 is electrically connected to housing 22 together with the reference potential point of feeding circuit 23. Furthermore, housing 22 of charging apparatus 2 is grounded by being electrically connected to a body that has a stable potential, such as the ground, with an electric conductor. Accordingly, the reference potential point of communication unit 41 is connected to the ground or the like via housing 22 which is the frame ground of charging apparatus 2. In charging apparatus 2, entire housing 22 does not necessarily have conductivity. When at least a part of housing 22 has conductivity and functions as the frame ground, the reference potential point of communication unit 41 is connected to the ground or the like via housing 22 which is the frame ground of charging apparatus 2. This configuration allows communication unit 41 to transmit the transmission signal by using the electric field with respect to the frame ground of charging apparatus 2 (potential of housing 22). That is, end points of electric force lines that come out of electrode 42 are converged on the frame ground of charging apparatus 2 (housing 22), which provides a stable electric field and reduces the transmission loss, hence improving the transmission efficiency and reducing spurious emission.

In accordance with the embodiment, in first communication terminal 3 provided in electric vehicle 1, the reference potential point of communication unit 31 is connected (grounded) to a conductive part of electric vehicle 1. The conductive part mentioned here is a section, such as a metal section, that has conductivity and has substantially the same potential as car body 13 including a frame and body. In general, the conductive part is electrically connected to a negative terminal of a battery for electric parts (different from secondary battery 11 for driving). In other words, connection of the reference potential point of communication unit 31 to the conductive part causes communication unit 31 to be grounded to the body. This configuration stabilizes electric field near electrode 32 and reduces the transmission loss, hence improving the transmission efficiency. In the communication between first communication terminal 3 and second communication terminal 4, electric field communication that mainly uses the electric field becomes more dominant. This configuration reduces electromagnetic waves that do not propagate through second conductor 602 or first conductor 601 and are emitted to space, hence reducing spurious emission.

That is, in electrode-attached communication terminal 3 communicates with the destination terminal, when communication unit 31 applies a signal to electrode 32, for example, an electric field occurs between conductive member 60 and the ground, as described above. At this moment, if the reference potential point of communication unit 31 is not connected to the conductive part, all of the conductive part that exists near electrode 32, neutral line 153, and the ground can become the end points of the electric force lines that start from electrode 32, which may lead to unstable electric field. In contrast, when the reference potential point of communication unit 31 is connected to the conductive part, the end points of the electric force lines that start from electrode 32 are converged on the conductive part. This results in stable electric field used for the electric field communication and improvement in the signal transmission efficiency. As a surface area of the conductive part increases, the above-described effect produced by connection of the reference potential point of communication unit 31 to the conductive part increases. This is caused by suppressing a ground bounce generated from an electric field coupling section.

In accordance with the embodiment, the reference potential point of communication unit 41 is grounded together with neutral line 243. That is, internal wire 24 as conductive member 60 (second conductor 603) of charging apparatus 2 includes neutral line 243 of N phase, as described above. Accordingly, electrode-attached communication terminal 4 has a configuration in which the reference potential point of communication unit 41 is electrically connected to neutral line 243 and is grounded together with neutral line 243. In the case that neutral line 243 is not grounded, when an electric field (signal) is superimposed on neutral line 243, interference may occur among a plurality of charging apparatuses 2 via the neutral line. The interference is likely to occur when the neutral line of the power source is common to charging apparatuses 2. When neutral line 243 is grounded as in the embodiment, the potential of neutral line 243 in the charging apparatuses 2 is compulsorily made uniform, and an electric field (signal) component superimposed on the neutral line decreases. Communication unit 41 can transmit the transmission signal by using the electric field that occurs between neutral line 243 and each of voltage lines 241 and 242, and a distance from a starting point to end point of the electric force line becomes short as compared with the case where the ground is the end point of the electric force line. Therefore, the electric force line becomes less susceptible to an obstacle or the like, which provides stable electric field and reduces the transmission loss, hence improving the transmission efficiency. As a distance to a grounding point of the neutral line decreases and a distance to charging apparatus 2 decreases, an effect of stable electric field increases.

### <Configuration of Communication System>

The communication system according to the embodiment includes first communication terminal 3 and second communication terminal 4 with the above-described configurations. That is, the communication system includes first communication terminal 3 provided in the first device, and second communication terminal 4 provided in the second device that exchanges the resource with the first device through the supply line. Second communication terminal 4 communicates with first communication terminals 3.

At least one of first communication terminal 3 and second communication terminal 4 includes electrode 32 (or 42) and communication unit 31 (or 41). Electrode 32 (or 42) is disposed with a space from conductive member 60 including at least one of first conductor 601 included in the supply line and second conductor 602 (or 603) electrically connected to first conductor 601, thereby being coupled via electric field to conductive member 60. Communication unit 31 (or 41) is electrically connected to electrode 32 (or 42) and communicates with the destination terminal by using the signal transmitted via conductive member 60 as a medium.

In accordance with the embodiment, the first device is electric vehicle 1 equipped with secondary battery 11. The second device is charging apparatus 2 that supplies electric power as the resource to the first device through the supply line (charging cable 5) and charges secondary battery 11.

### <Operation of Communication System>

Using the communication system of the present exemplary embodiment described above enables charging system 10 to perform the following operations. That is, by mutual communication between first communication terminal 3 provided in electric vehicle 1 (first device) and second communication terminal 4 provided in charging apparatus 2 (second device), charging system 10 becomes able to give and receive signals between electric vehicle 1 and charging apparatus 2.

In charging system 10, while electric vehicle 1 is electrically connected to charging apparatus 2 via charging cable 5, electric power is supplied from feeding circuit 23 of charging apparatus 2 to charging circuit 14 of electric vehicle 1, thereby charging secondary battery 11 of electric vehicle 1. In charging apparatus 2, for example, in order to perform billing according to an amount of charging or in order to determine whether electric vehicle 1 is a vehicle that is permitted to receive electric power, performing an authentication process of electric vehicle 1 is considered. Therefore, by using the communication system described above, charging system 10 can exchange signals necessary for the authenticating process of electric vehicle 1 between electric vehicle 1 and charging apparatus 2.

While charging electric vehicle 1, when electric vehicle 1 is connected via charging cable 5, charging apparatus 2 first acquires identification information from electric vehicle 1 by communication. The identification information of electric vehicle 1 is information that corresponds uniquely to electric vehicle 1, and is registered previously in first communication terminal 3 provided in electric vehicle 1. The identification information is registered, for example, by being set previously at a time of manufacturing of first communication terminal 3, or by being recorded in a memory of first communication terminal 3 with a dedicated setting device.

When electric vehicle 1 is connected to charging apparatus 2 via charging cable 5 and causes first communication terminal 3 to communicate with second communication terminal 4, first communication terminal 3 starts transmitting the identification information automatically. First communication terminal 3 repetitively transmits the identification information plural times at predetermined time intervals. Second communication terminal 4 acquires the identification information on electric vehicle 1 by receiving at least once the identification information transmitted from first communication terminal 3. That is, first communication terminal 3 is configured to transmit, to second communication terminal 4, the identification information unique to the first device (electric vehicle 1) by the communication with second communication terminal 4.

Upon acquiring the identification information on electric vehicle 1, second communication terminal 4 verifies the identification information against reference information previously registered. The reference information is identification information formally registered, and is previously registered in second communication terminal 4 provided in charging apparatus 2. The reference information is registered, for example, by being written in a memory of second communication terminal 4. Alternatively, in the case that second communication terminal 4 has a communication function with an authentication server, the reference information may be registered previously in the authentication server. In this case, second communication terminal 4 transmits the identification information of electric vehicle 1 to the authentication server, and then, the authentication server authenticates the identification information.

Second communication terminal 4 or the authentication server that authenticates the identification information determines that the verification is a success when the registered reference information matches with the acquired identification information. Second communication terminal 4 or the authentication server determines that the verification is a failure when the registered reference information matches with the acquired identification information. When the authentication server authenticates the identification information, the authentication server transmits information on whether the verification of the identification information succeeds or not to second communication terminal 4 as an authentication result of the identification information. Then, when the verification of the identification information succeeds, second communication terminal 4 starts supplying electric power from the second device (charging apparatus 2) to the first device (electric vehicle 1). On the other hand, second communication terminal 4 is configured not to cause electric power to be supplied from the second device (charging apparatus 2) to the first device (electric vehicle 1) when the verification of the identification information does not succeed. That is, depending on the authentication result of the identification information, second communication terminal 4 controls feeding circuit 23 of charging apparatus 2 and switches whether or not to supply electric power from charging apparatus 2 to electric vehicle 1.

### <Advantageous Effects>

In the configuration using wireless communications described in PTL 2, when plural devices that can be communication partners exist near one device, it is difficult to perform one-to-one communication. For example, when two electric vehicles approach one charging apparatus, both of the two electric vehicles can communicate with the charging apparatus, and thus, it is difficult for the charging apparatus to identify which of the two electric vehicles is to be charged.

Electrode-attached communication terminal 3, communication terminal 30, and the communication system according to the embodiment described above can communicate via electric field with the destination terminal by using conductive member 60 as a medium with the destination terminal and exchanging signals. Since the electric field communication mentioned here mainly uses electric field attenuating in proportion to the third power of a distance when propagating through space, communication can be established between terminals connected via a specified communication path in space although non-contact instead of an unspecified path. That is, in the electric field communication, since the signal that propagates through space immediately attenuates and the signal propagates mainly through conductive member 60 with little attenuation, communication between terminals connected via the specified communication path is established. Therefore, by using conductive member 60 as the communication path, electrode-attached communication terminal 3 can establish communication with the destination terminal only after the first device and the second device are connected via the supply line (charging cable 5). As a result, even when plural devices that can be communication partners exist near one device, one-to-one communication can be performed.

Electrode 32 is coupled via electric field to conductive member 60, thereby positively superimposing an electric field component of the transmission signal applied by transmitting circuit 311 on second conductor 602 or first conductor 601. Electrode 32 is coupled via electric field to conductive member 60 by being wound on the sheath around existing internal wire 15 or charging cable 5, hence allowing electrode-attached communication terminal 3 to be easily installed to the existing device (first device) by post-installation. That is, electrode 32 is coupled via electric field to the medium (conductive member 60), and allows electrode-attached communication terminal 3 to being capable of communication even if electrode 32 is not directly connected to the medium, thus being easily installed by post-installation. Since it is unnecessary to process internal wire 15 or charging cable 5 for installing electrode 32, electrode-attached communication terminal 3 once installed can be moved. Alternatively, even when electrode-attached communication terminal 3 is installed in the device (first device) from the beginning (at the time of manufacturing of the device), electrode-attached communication terminal 3 which requires neither soldering nor special connectors reduces installation costs or time and effort.

Also, in the communication system according to the embodiment, the first device is electric vehicle 1 equipped with secondary battery 11, whereas the second device is charging apparatus 2. Charging apparatus 2 supplies electric power as the resource to the first device through the supply line (charging cable 5), and charges secondary battery 11. This configuration allows the communication system to perform the communication between electric vehicle 1 and charging apparatus 2 in charging system 10. Therefore, in charging system 10, for example, in order to perform billing according to an amount of charging, or in order to determine whether electric vehicle 1 is a vehicle that is permitted to be charged or not, the authentication process of electric vehicle 1 can be performed.

Since communication is established with the destination terminal only after the first device and the second device are connected via the supply line (charging cable 5), even when plural charging apparatuses 2 are installed side by side, electrode-attached communication terminal 3 can perform one-to-one communication between electric vehicle 1 and charging apparatus 2. Even when plural electric vehicles 1 are located near one charging apparatus 2, one-to-one communication between electric vehicle 1 and charging apparatus 2 can be performed. As a result, this communication system can perform one-to-one communication even when plural devices that can be communication partners exist near the one device.

Here, as in the embodiment, first communication terminal 3 is preferably configured to transmit the identification information assigned uniquely to the first device (electric vehicle 1) to second communication terminal 4 by communication with second communication terminal 4. Accordingly, for example, in order to perform billing according to the amount of charging or in order to determine whether or not electric vehicle 1 is a vehicle that is permitted to be charged, the authentication process of electric vehicle 1 can be performed by using the identification information transmitted from first communication terminal 3 to second communication terminal 4.

Second communication terminal 4 is configured not to cause electric power to be supplied from the second device (charging apparatus 2) to the first device (electric vehicle 1) when the verification of the identification information does not succeed. Therefore, when the verification of the identification information does not succeed due to a device other than authorized electric vehicle 1 connected or other reasons, charging apparatus 2 does not supply electric power, thereby preventing useless electric power supply to an unauthorized device.

Electric vehicle 1 is used as the first device in the communication system and includes first communication terminal 3. Therefore, even when plural devices (charging apparatuses 2) that can be communication partners exist near one electric vehicle 1, electric vehicle 1 can perform one-to-one communication with charging apparatus 2 actually connected via charging cable 5.

Charging apparatus 2 is used as the second device in the communication system and includes second communication terminal 4. Therefore, even when plural devices (electric vehicles 1) that can be communication partners exist near one charging apparatus 2, charging apparatus 2 can perform one-to-one communication with electric vehicle 1 actually connected via charging cable 5.

The relationship between the first device and the second device is not limited to the example of the exemplary embodiment described above, and may be opposite. That is, the first device may be charging apparatus 2, whereas the second device may be electric vehicle 1. In this case, electrode-attached communication terminal 4 provided in charging apparatus 2 that is the first device is the first communication terminal, whereas electrode-attached communication terminal 3 provided in electric vehicle 1 that is the second device is the second communication terminal. When charging apparatus 2 is interpreted as the first device, for example, the configuration described in the section, “<Detail of electrode-attached communication terminal>” can be interpreted as the reference potential point of communication unit 41 being grounded via the frame ground of the first device (charging apparatus 2).

The first device may not necessarily be electric vehicle 1, but may be any device to which electric power is supplied from the second device. The first device may be, for example, a stationary electric storage device. The first device and the second device may have any configuration to exchange the resource through the supply line. The resource may not necessarily be electric power. For example, in the case that the resource is oil fuel, such as gasoline or diesel oil, automobiles and two-wheel vehicles that uses the oil fuel is the first device, whereas an oiling device is the second device. For example, in the case where the resource is gasoline and a pipe and nozzle which are supply lines of the resource are made of metal, when the nozzle is inserted into an oil filler opening of a vehicle, a connection is established between the vehicle and the oiling device, and a communication is established between the first communication terminal and the second communication terminal. In the case that the resource is hydrogen, a fuel cell vehicle that uses hydrogen is the first device, whereas a hydrogen supply device is the second device.

### Exemplary Embodiment 2

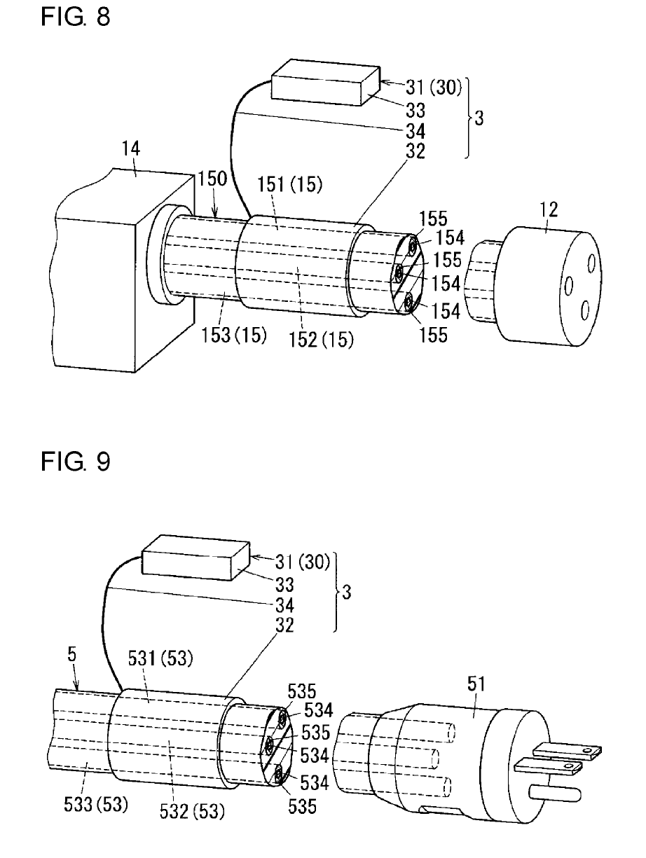

FIG. 8 is a perspective view of a main part of a first communication terminal according to Embodiment 2 for illustrating one example of an installation state thereof. An electrode-attached communication terminal according to the embodiment is different from the electrode-attached communication terminal according to Embodiment 1 in a coupling state of electrode 32 to conductive member 60. Hereinafter, components identical to those of Embodiment 1 are denoted by the same reference numerals, and their description will be omitted.

In accordance with the embodiment, electrode 32 of electrode-attached communication terminal 3 (a first communication terminal) provided in electric vehicle 1 (a first device) is configured to be coupled via electric field to all of neutral line 153 and voltage lines 151 and 152, as illustrated in FIG. 8. That is, according to the embodiment, similarly to Embodiment 1, a resource exchanged between the first device (electric vehicle 1) and a second device (charging apparatus 2) is electric power, and conductive member 60 includes neutral line 153 and voltage lines 151 and 152. While electrode 32 is coupled via electric field only to voltage lines 151 and 152 out of neutral line 153 and voltage lines 151 and 152 in accordance with Embodiment 1, electrode 32 is coupled via electric field to all of neutral line 153 and voltage lines 151 and 152 in accordance with the present embodiment.

In accordance with the present embodiment, in detail, as internal wire 15 of electric vehicle 1, one pair of voltage lines 151 and 152 which are an L1 phase and an L2 phase, and neutral line 153 which is an N phase constitute one internal cable 150. That is, internal cable 150 includes three internal wires 15 in total including the pair of voltage lines 151 and 152 and neutral line 153 which are covered with an insulating sheath (an outer covering) and bundled into one cable. Accordingly, in the first device (electric vehicle 1), one internal cable 150 electrically connects charging inlet 12 to charging circuit 14. As illustrated in FIG. 8, electrode 32 performs electric field coupling to conductive member 60 (second conductor 602) by being wound on the sheath around internal cable 150 without processing internal cable 150.

The configuration of the present exemplary embodiment described above allows electrode 32 to be installed over the outer covering (sheath) of internal cable 150 even when plural internal wires 15 are bundled and constitute the cable (internal cable 150) inside the first device (electric vehicle 1). Therefore, an operator who installs electrode-attached communication terminal 3 allows electrode 32 to be coupled via electric field to core wire 154 of internal wire 15 as second conductor 602 without processing internal cable 150, and post-installation in electric vehicle 1 is easy.

In the configuration of the present exemplary embodiment, as described in the first exemplary embodiment, an effect provided by a reference potential point of communication unit 41 being grounded together with neutral line 243 increases. This is because interference among plural charging apparatuses 2 described above occurs conspicuously in a portion of conductive member 60 that is coupled via electric field to electrode 42 due to an electric field (signal) more positively superimposed on neutral line 243. That is, in the configuration of the present exemplary embodiment, the reference potential point of communication unit 41 is grounded together with neutral line 243 to reduce an electric field (signal) component superimposed on neutral line 243 and significantly prevent interference among plural charging apparatuses 2.

Other configurations and functions are similar to configurations and functions of the first exemplary embodiment.

### Exemplary Embodiment 3

FIG. 9 is a perspective view of a main part of a first communication terminal according to Exemplary Embodiment 3 for illustrating an example of an installation state thereof. An electrode-attached communication terminal according to the present embodiment is different from the electrode-attached communication terminal according to Embodiment 1 in a coupling state of electrode 32 to conductive member 60. Hereinafter, components identical to those of the terminal according to Embodiment 1 are denoted by the same reference numerals, and their description will be omitted.

In the present exemplary embodiment, as illustrated in FIG. 9, electrode 32 of electrode-attached communication terminal 3 (a first communication terminal) provided in electric vehicle 1 (a first device) is coupled via electric field to core wire 534 of electric wire 53 included in charging cable 5, first conductor 601. In the present exemplary embodiment, similarly to Embodiment 1, a resource exchanged between the first device (electric vehicle 1) and a second device (charging apparatus 2) is electric power, and conductive member 60 includes neutral line 533 and voltage lines 531 and 532. In the present exemplary embodiment, electrode 32 is coupled via electric field to all of neutral line 533 and voltage lines 531 and 532 similarly to Embodiment 2.

In detail, charging cable 5 includes neutral line 533 which is an N phase and one pair of voltage lines 531 and 532 which are an L1 phase and an L2 phase which are bundled into one cable with an insulating sheath (outer covering) thereon. Accordingly, one charging cable 5 electrically connects the first device (electric vehicle 1) to the second device (charging apparatus 2). As illustrated in FIG. 9, electrode 32 performs electric field coupling to conductive member 60 (first conductor 601) by being wound on the sheath around charging cable 5 without processing charging cable 5.

The configuration of the present exemplary embodiment described above allows electrode 32 to be installed to charging cable 5, which is the supply line, over the outer covering (sheath). Therefore, an operator who installs electrode-attached communication terminal 3 can cause electrode 32 to be coupled via electric field to core wire 534 of electric wire 53 as first conductor 601 without processing charging cable 5.

The configuration in which electrode 32 is installed to charging cable 5 as described in the present exemplary embodiment is particularly useful in electric vehicle 1 with the configuration in which charging cable 5 is not detachable. That is, electric vehicle 1 may lack charging inlet 12 to which connector 52 of charging cable 5 is detachably connected and employ the configuration in which charging cable 5 is electrically connected to charging circuit 14 directly. In electric vehicle 1 with such a configuration, charging cable 5 is accommodated inside car body 13 except when secondary battery 11 is charged, and when secondary battery 11 is charged, charging cable 5 is pulled out of car body 13 and is connected to charging apparatus 2. In electric vehicle 1 with such a configuration, charging cable 5 is typically provided at a position where a user of electric vehicle 1 can touch, hence simplifying an operation of installing electrode 32 to charging cable 5.

The configuration of the present exemplary embodiment is applicable not only to first communication terminal 3 but also to second communication terminal 4. That is, electrode 42 of electrode-attached communication terminal 4 (a second communication terminal) provided in charging apparatus 2 (the second device) may be coupled via electric field to core wire 534 of electric wire 53 included in charging cable 5, which is first conductor 601. This configuration is particularly useful in charging apparatus 2 with the configuration in which charging cable 5 is not detachable. That is, charging apparatus 2 may lack charging plug socket 21 to which plug 51 of charging cable 5 is detachably connected and employ the configuration in which charging cable 5 is electrically connected to feeding circuit 23 directly. In this kind of charging apparatus 2, charging cable 5 is typically provided at a position where a user of charging apparatus 2 can touch, hence particularly simplifying an operation of installing electrode 42 in charging cable 5.

Other configurations and functions are similar to configurations and functions of Embodiment 1.

### Exemplary Embodiment 4

A communication system according to Exemplary Embodiment 4 is different from the communication system according to Embodiment 1 in that only one of first communication terminal 3 and second communication terminal 4 includes electrode 32 (or 42) coupled via electric field to conductive member 60. Components identical to those of the terminal according to Embodiment 1 are denoted by the same reference numerals, and their description will be omitted.

The present exemplary embodiment describes an example in which, only first communication terminal 3 provided in electric vehicle 1 (a first device) out of first communication terminal 3 and second communication terminal 4 includes electrode 32. In the present embodiment, in second communication terminal 4 provided in charging apparatus 2 (a second device), communication unit 41 is electrically connected directly to conductive member 60 (at least one of first conductor 601 and second conductor 603).

In this configuration, between first communication terminal 3 and second communication terminal 4, only electrode 32 of first communication terminal 3 and conductive member 60 are coupled to each other while not contacting each other, and except for this coupling, a communication path is configured to be directly connected via conductive member 60. This results in a smaller transmission loss between first communication terminal 3 and second communication terminal 4 than a case where both electrode 32 of first communication terminal 3 and electrode 42 of second communication terminal 4 are coupled to conductive member 60 while not contacting each other. That is, for example, in the case that charging apparatus 2 includes second communication terminal 4 from the beginning (at a time of manufacturing of the device), post-installation of second communication terminal 4 in the device (charging apparatus 2) is not needed. The configuration of the present exemplary embodiment reduces the transmission loss.

In this configuration, since electrode 32 of first communication terminal 3 provided in electric vehicle 1 is coupled to conductive member 60 while not contacting, electric vehicle 1 does not necessarily include first communication terminal 3 from the beginning (at the time of manufacturing of the electric vehicle). Also, processing for installing electrode 32 around a supply line through which a large electric current flows in electric vehicle 1 is not necessary, hence simplifying an operation for installation of first communication terminal 3 and reducing a cost of electric vehicle 1. In particular, for a two-wheel vehicle or the like which is relatively inexpensive among electric vehicles 1, the effect of cost reduction of electric vehicle 1 is large. Also, first communication terminal 3 can be easily installed in vehicles that have already appeared on the market by post-installation, and is applicable to a lot of vehicle models without involving system changes.

The configuration of the present exemplary embodiment is not limited to the above-described example. Only second communication terminal 4 out of first communication terminal 3 and second communication terminal 4 which is provided in charging apparatus 2 (a second device) may include electrode 42. In this case, in first communication terminal 3 provided in electric vehicle 1 (a first device), communication unit 31 is electrically connected directly to conductive member 60 (at least one of first conductor 601 and second conductor 602).

In this configuration, between first communication terminal 3 and second communication terminal 4, only electrode 42 of second communication terminal 4 is coupled to conductive member 60 while not contacting conductive member 60, and except for this coupling, a communication path is to be formed that is directly connected via conductive member 60. This results in a smaller transmission loss between first communication terminal 3 and second communication terminal 4 than a case where both electrode 32 of first communication terminal 3 and electrode 42 of second communication terminal 4 are coupled to conductive member 60 while not contacting. That is, for example, in the case that electric vehicle 1 includes first communication terminal 3 from the beginning (at a time of manufacturing of the device), post-installation of first communication terminal 3 in the device (electric vehicle 1) is not needed, and thus employment of the configuration of the present exemplary embodiment reduces the transmission loss.

Other configurations and functions are similar to configurations and functions of Embodiment 1. Also, the configuration of the present exemplary embodiment is applicable in combination with the configuration of each of Embodiments 2 and 3, in addition to the configuration of Embodiment 1.

### Exemplary Embodiment 5

The following exemplary embodiment describes an electrode-attached communication terminal, communication terminal, communication system, electric vehicle, and charging apparatus which are used in a charging system of an electric vehicle equipped with a secondary battery as one example. The following first describes an outline of the charging system.

### <Outline of Charging System>

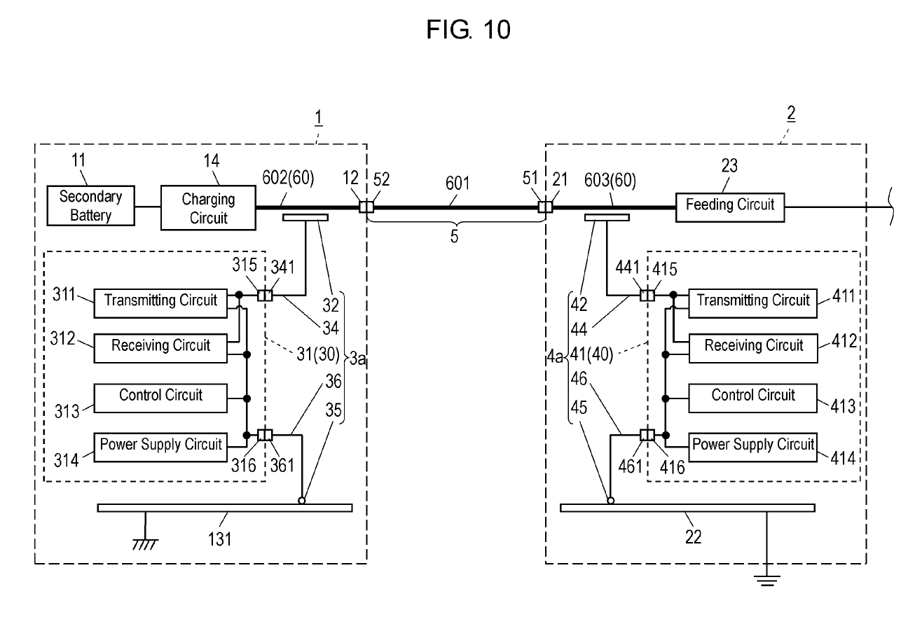

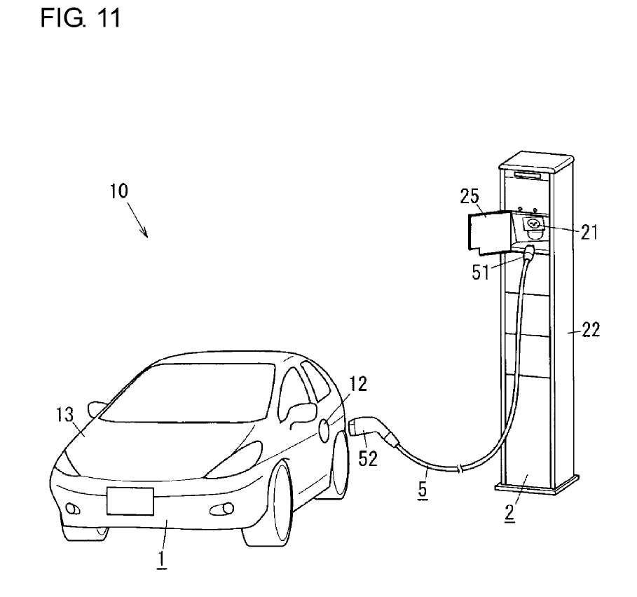

FIG. 10 is a block diagram of a communication system according to Exemplary Embodiment 5. FIG. 11 is a schematic diagram of charging system 10 that uses the communication system according to Embodiment 5. In FIG. 10 and FIG. 11, components identical to those of the communication system and charging system 10 according to Embodiment 1 illustrated in FIG. 1 and FIG. 2 are denoted by the same reference numerals. Charging system 10 includes electric vehicle 1 and charging apparatus 2 as illustrated in FIG. 11.

While the following describes the configuration of the electrode-attached communication terminal by taking first communication terminal 3a as an example, in the present exemplary embodiment, the electrode-attached communication terminal with the configuration identical to the configuration of first communication terminal 3a is also used as second communication terminal 4a. Therefore, unless otherwise specified, the following describes the electrode-attached communication terminal as first communication terminal 3a (also referred to as “electrode-attached communication terminal 3a”), and the description of the electrode-attached communication terminal as second communication terminal 4a (also referred to as “electrode-attached communication terminal 4a”) is omitted.

As illustrated in FIG. 10, electrode-attached communication terminal 3a according to the present exemplary embodiment includes communication unit 31, electrode 32, and ground terminal 35.

Communication unit 31 is provided in a vehicle (first device), and is configured to communicate with a destination terminal (second communication terminal 4a). The destination terminal is provided in a supply apparatus (a second device) that supplies a resource through a supply line (charging cable 5) to the vehicle. Electrode 32 is disposed with a space from conductive member 60 as to be coupled via electric field to conductive member 60. Conductive member 60 includes at least one of first conductor 601 included in the supply line (charging cable 5) and second conductor 602 electrically connected to first conductor 601. Ground terminal 35 is a reference potential point of communication unit 31.

Communication unit 31 is electrically connected to electrode 32 and ground terminal 35, and is configured to perform communication with the destination terminal by using a signal transmitted via conductive member 60 as a medium. Ground terminal 35 is electrically connected to conductive part 131 made of a conductive material in the vehicle.

Thai is, electrode-attached communication terminal 3a provides non-contact electrical coupling between electrode 32 and conductive member 60 by causing electrode 32 to be coupled via electric field to conductive member 60. In this state, a signal with the destination terminal is exchanged by using conductive member 60 as a medium to allow electrode-attached communication terminal 3a to perform electric field communication with the destination terminal. The electric field communication mentioned here is communication that causes a predetermined signal to propagate through a particular communication path (here, conductive member 60) mainly by using a static electrostatic field or quasi-electrostatic field. For example, the electric field communication is communication that transmits a predetermined signal by using an electric field that occurs between conductive member 60 and the ground. Components of such an electric field (static electrostatic field or quasi-electrostatic field) attenuates in proportion to the third power of distance from electrode 32 when propagating through space. That is, the electric field used by the electric field communication mentioned here rapidly attenuates when the distance increases depending on the distance from electrode 32. Unlike radiated waves of wireless communication, the signal transmitted by this electric field communication does not have a property to propagate through space with little attenuation. This electric field communication establishes communication between terminals connected through a particular communication path instead of an unspecified path in space. Also, in the electric field communication mentioned here, since attenuation of the electric field while propagating through conductive member 60 is smaller than a case of propagating through space, communication can be established with very small energy although non-contact as compared with wireless communication using radiated waves.

Moreover, in the above-described configuration, ground terminal 35, which is the reference potential point of communication unit 31, is electrically connected to conductive part 131 in electrode-attached communication terminal 3a. Conductive part 131 mentioned here is a section that has electric conductivity, such as a metal section that is substantially equipotential in car body 13 including a frame and body (refer to FIG. 11). In general, conductive part 131 is electrically connected to a negative terminal of a battery for electric parts (different from secondary battery 11 for driving). In other words, connection of ground terminal 35 to conductive part 131 causes communication unit 31 to be grounded to the body. This reduces impedance of the reference potential point of communication unit 31 as compared with a case where ground terminal 35 is not electrically connected to conductive part 131 (electrically isolated), and thus potential of the reference potential point is likely to be stable.

In more detail, in a case where electrode-attached communication terminal 3a communicates with the destination terminal, when communication unit 31 applies a signal to electrode 32, for example, an electric field occurs between conductive member 60 and the ground, as described above. At this time, if ground terminal 35 is not connected to conductive part 131, both conductive part 131 that exists near electrode 32 and the ground can be end points of electric force lines that start from electrode 32, which may cause the electric field to be unstable. For example, one electric force line flows along a path from electrode 32 as a starting point to conductive part 131 as an end point, and from conductive part 131 as a starting point to the ground as an end point. Another electric force line flows along a path extending to the ground directly from electrode 32. Thus, various electric fields (paths of electric force lines) exist, and the signal used in the above-described electric field communication is likely to be affected by an installation position of electrode-attached communication terminal 3a and conductive part 131 around electrode-attached communication terminal 3a. Accordingly, the unstable electric field may bring about variations in a signal transmission efficiency and reduction in the signal. Meanwhile, when ground terminal 35, which is the reference potential point of communication unit 31, is connected to conductive part 131, the end points of the electric force lines that start from electrode 32 is converged on conductive part 131. This results in the stable electric field used in the electric field communication and improvement in the signal transmission efficiency.

Conductive member 60 is preferably made of metal. Although communication can be established even if conductive member 60 is made of a conductive resin, such as a conductive polymer, since metal generally has larger conductivity than a conductive resin, conductive member 60 made of metal can reduce a loss in the communication path. Also, for example, although communication can be established even if a medium that is mainly made of water is used as conductive member 60, such as a human body, water hose, and piping for water, this medium may produce large loss in the communication path similarly to the conductive resin. Furthermore, such a medium mainly made of water does not have a stable shape, and for example, substantial electroconductivity of a human body changes depending on a posture thereof or the like. Therefore, conductive member 60 made of metal is preferable in terms of stable communication.

In the present exemplary embodiment, as one example, the vehicle is electric vehicle 1, the supply apparatus is charging apparatus 2, the supply line is charging cable 5, and the resource is electric power (electric energy). Also, in the present exemplary embodiment, for first communication terminal 3a provided in electric vehicle 1, second communication terminal 4a is the destination terminal, and first communication terminal 3a is to communicate with second communication terminal 4a. Conversely, for second communication terminal 4a provided in charging apparatus 2, first communication terminal 3a is the destination terminal, and second communication terminal 4a is to communicate with first communication terminal 3a.

The electrode-attached communication terminal according to the present exemplary embodiment will be described in detail below. However, the configuration to be described below is only one example of the present invention, the present invention is not necessarily the following exemplary embodiment, and various changes according to design or the like can be made even other than this exemplary embodiment without departing from technical ideas according to the present invention.

### <Configuration of Electrode-Attached Communication Terminal>

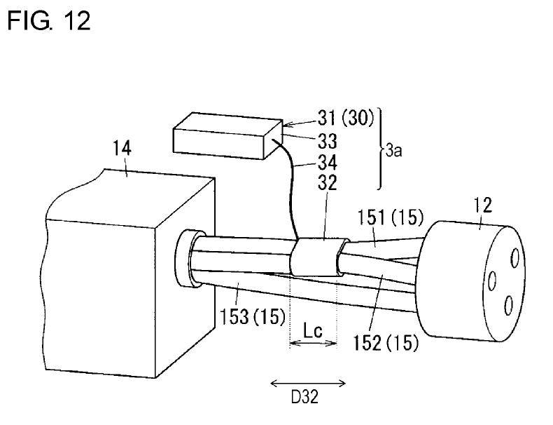

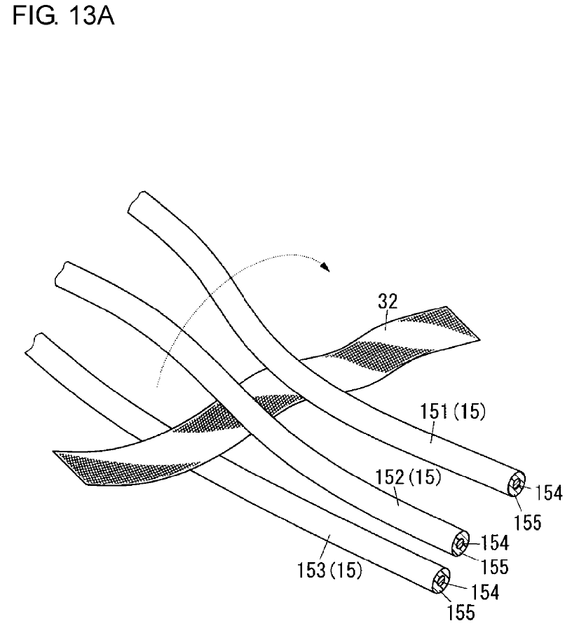

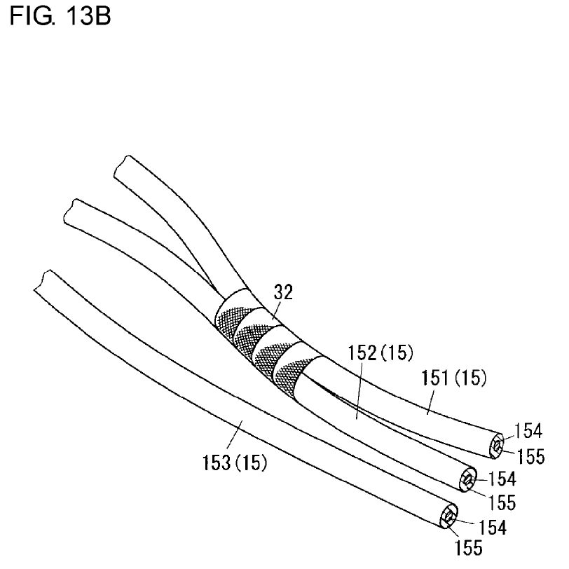

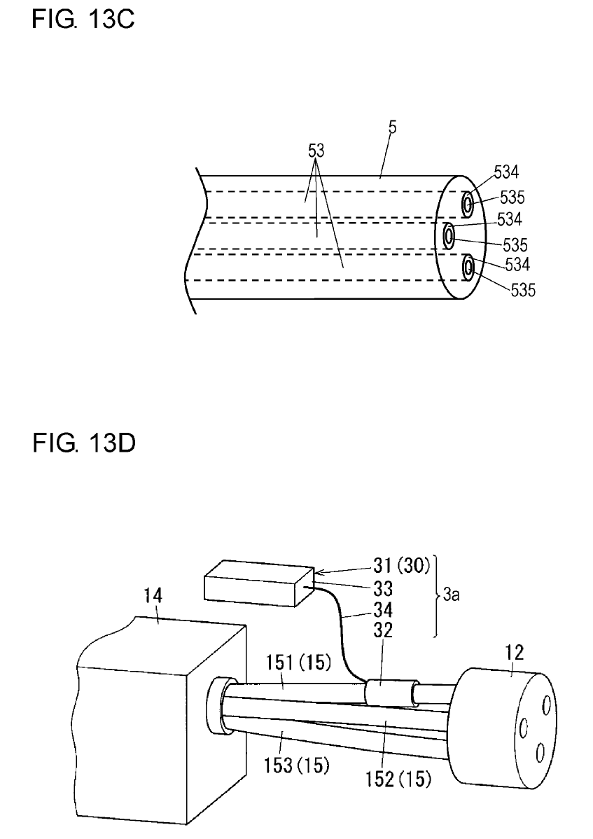

FIG. 12 is a perspective view of a main part of the first communication terminal according to Embodiment 5 for illustrating one example of an installation state thereof. FIG. 13A and FIG. 13B are perspective views of a main part of electrode 32 for illustrating an installation process thereof. In addition to communication unit 31, electrode 32, and ground terminal 35 described above, electrode-attached communication terminal 3a of the present exemplary embodiment further includes case 33 that is an enclosure of communication unit 31 (refer to FIG. 12), cable 34, and cable 36. Cable 34 connects communication unit 31 to electrode 32. Cable 36 connects communication unit 31 to ground terminal 35.

Electrode 32 is electrically connected to communication unit 31 via cable 34. Since electrode-attached communication terminal 3a of the present exemplary embodiment performs electric field communication while electrode 32 is electrically coupled to conductive member 60 and does not contact conductive member 60, electrode 32 is used while electrode 32 does not directly contact conductive member 60.

FIG. 13C is a perspective view of charging cable 5 which is the supply line in Embodiment 1. Since the supply line is charging cable 5 in the present exemplary embodiment, first conductor 601 included in the supply line includes core wire 534 of electric wire 53 included in charging cable 5. Also, second conductor 602 electrically connected to first conductor 601 includes core wire 154 (refer to FIG. 13A) of internal wire 15 (refer to FIG. 12) that electrically connects charging inlet 12 to charging circuit 14 in the vehicle (electric vehicle 1). Each of these electric wires (electric wire 53 and internal wire 15) is, for example, a vinyl insulated wire in which a copper core wire is covered with a sheath of vinyl or the like. Electrode 32 is disposed with a space from conductive member 60 including at least one of first conductor 601 and second conductor 602 as described above, thereby having being coupled via electric field to conductive member 60. In the present exemplary embodiment, conductive member 60 includes second conductor 602, and electrode 32 is coupled via electric field to second conductor 602.

In the present exemplary embodiment, electrode 32 is configured to be coupled via electric field to conductive member 60 by being capacitively coupled to conductive member 60. A capacitance component formed between electrode 32 and conductive member 60 (hereinafter referred to as “coupling capacitance”) is determined by a distance from electrode 32 to conductive member 60 and a dielectric constant of a substance that lies between electrode 32 and conductive member 60. A space large enough to form the coupling capacitance may be provided between electrode 32 and conductive member 60, that it is not essential that sheath 155 lies between electrode 32 and conductive member 60, and that, for example, a gap (space) may exist between electrode 32 and conductive member 60.

Electrode 32 coupled via electric field to conductive member 60 by capacitive coupling can reduce a coupling loss between electrode 32 and conductive member 60. Although electric field coupling between electrode 32 and conductive member 60 can also be performed, for example, by disposing electrode 32 including electric wires to be entwined in conductive member 60, such electric field coupling causes a larger coupling loss than capacitive coupling. In capacitive coupling, electrode 32 faces a surface of conductive member 60 in parallel, hence reducing the coupling loss between electrode 32 and conductive member 60.

As detailed later, electrode 32 is preferably made of a conductive sheet. For example, electrode 32 is more preferably made of, e.g. a mesh metal sheet, a metal foil, or a metal tape.

As illustrated in FIG. 10, communication unit 31 includes transmitting circuit 311, receiving circuit 312, control circuit 313, and power supply circuit 314. Transmitting circuit 311, receiving circuit 312, control circuit 313, and power supply circuit 314 are disposed inside case 33.

Transmitting circuit 311 is electrically connected to electrode 32, and is configured to generate a transmission signal that contains information by modulating a carrier wave (carrier) and to apply the transmission signal to electrode 32. Here, transmitting circuit 311 uses, for example, a rectangular wave with a frequency of about 10 [MHz] as the carrier wave, and employs On Off Keying (OOK) as a modulation method. When transmitting circuit 311 applies the transmission signal to electrode 32, an electric field (quasi-electrostatic field) is induced in conductive member 60 coupled via electric field to electrode 32. The electric field induced in conductive member 60 propagates through conductive member 60 with very small attenuation, and then, reaches the supply apparatus (charging apparatus 2). Receiving circuit 412 of the destination terminal (second communication terminal 4a) provided in the supply apparatus receives the transmission signal.

Receiving circuit 312 is electrically connected to electrode 32, and is configured to receive the transmission signal from the destination terminal. Here, receiving circuit 312 receives the transmission signal induced in electrode 32 by the electric field that occurs in conductive member 60 coupled via electric field to electrode 32. Then, receiving circuit 312 demodulates the transmission signal as to extract information contained in the transmission signal.

Control circuit 313 mainly includes a micro processing unit (MPU), and is configured to control transmitting circuit 311 and receiving circuit 312. This configuration allows communication unit 31 to communicate with the destination terminal (second communication terminal 4a) by using the signal transmitted via conductive member 60 as a medium. Communication unit 31 which includes both transmitting circuit 311 and receiving circuit 312 can exchange the transmission signal, and can perform bidirectional communication with the destination terminal.

Power supply circuit 314 is configured to supply electric power for operations to each of transmitting circuit 311, receiving circuit 312, and control circuit 313. Power supply circuit 314 includes, for example, a primary battery as a power supply, and supplies electric power of the primary battery to each circuit.

Ground terminal 35 is electrically connected to communication unit 31 via cable 36. Ground terminal 35 is electrically connected to each of transmitting circuit 311, receiving circuit 312, control circuit 313, and power supply circuit 314. Ground terminal 35 functions as the reference potential point of each circuit. That is, for power supply circuit 314, for example, since ground terminal 35 is electrically connected to an output terminal on a low potential (negative pole) side, power supply circuit 314 outputs a voltage corresponding to a potential difference between an output terminal on a high potential (positive pole) side and ground terminal 35 as a power supply voltage.

As detailed later, ground terminal 35 preferably has a structure suitable for taking a body ground as a spade terminal, for example. That is, ground terminal 35 out of car body 13 of electric vehicle 1 is electrically connected to conductive part 131 made of a conductive material, and thus ground terminal 35 preferably has a structure suitable for electric connection to conductive part 131.

Communication unit 31 is configured to communicate with the destination terminal while the vehicle and the supply apparatus are connected via the supply line. Communication unit 31 is configured not to communicate with the destination terminal while the vehicle and the supply apparatus are not connected via the supply line. In the present exemplary embodiment, as described above, the vehicle is electric vehicle 1, the supply apparatus is charging apparatus 2, and the supply line is charging cable 5. For first communication terminal 3a provided in electric vehicle 1, second communication terminal 4a is the destination terminal. Therefore, communication unit 31 of first communication terminal 3a communicates with second communication terminal 4a while electric vehicle 1 and charging apparatus 2 are connected via charging cable 5. Communication unit 31 does not communicate with second communication terminal 4a while electric vehicle 1 and charging apparatus 2 are not connected. It is determined, based on a detection result of a connection detector that detects a connection state of plug 51 of charging cable 5 to charging plug socket 21, whether electric vehicle 1 and charging apparatus 2 are connected via charging cable 5 or not.

When the connection detector detects that plug 51 is connected to charging plug socket 21, communication unit 31 determines that the vehicle and the supply apparatus are connected via the supply line, and communication unit 31 communicates with second communication terminal 4a, which is the destination terminal. On the other hand, when the connection detector detects that the connection between plug 51 and charging plug socket 21 is canceled, communication unit 31 determines that the vehicle and the supply apparatus are not connected via the supply line, and does not communicate with second communication terminal 4a which is the destination terminal. The connection detector may be included in communication unit 31, and may be provided separately from communication unit 31. The connection detector is configured to detect the connection state of plug 51 of charging cable 5 to charging plug socket 21 optically, for example, by using reflection of infrared light or the like, or to detect the connection state electrically based on an energizing state. Instead of the connection state of plug 51 to charging plug socket 21, the connection detector may be configured to detect the connection state of connector 52 of charging cable 5 to charging inlet 12.

That is, first communication terminal 3a and second communication terminal 4a mainly use an electric field component attenuating in proportion to the third power of the distance from electrode 32 when propagating through space, and performs electric field communication by which a predetermined signal propagates through a particular communication path (here, conductive member 60). Accordingly, even while electric vehicle 1 and charging apparatus 2 are not connected via charging cable 5, first communication terminal 3a and second communication terminal 4a can be in a communicative state, such as when plug 51 of charging cable 5 is just near charging plug socket 21. By communicating with the destination terminal only while vehicle and the supply apparatus are connected via the supply line as described above, communication unit 31 can perform communication only when connected through a wire similarly to wired communication although non-contact.

The connection detector for determining whether or not electric vehicle 1 is connected to charging apparatus 2 via charging cable 5 is not a required component. The communication system of the present exemplary embodiment functions when the vehicle is connected to the supply apparatus via the supply line and first communication terminal 3a can communicate with second communication terminal 4a. For example, when second communication terminal 4a receives a signal transmitted from first communication terminal 3a, the communication path for electric field communication is not established before electric vehicle 1 is connected to charging apparatus 2 (connected via charging cable 5). Accordingly, the signal from first communication terminal 3a is to propagate through space before reaching second communication terminal 4a, and signal reception strength at second communication terminal 4a is extremely low. When electric vehicle 1 is connected to charging apparatus 2 (connected via charging cable 5) in this state, the communication path for electric field communication is established, and the signal reception strength at second communication terminal 4a increases rapidly.

A signal reception strength difference changes from, for example, 40 [dB] to 70 [dB] before and after connection between electric vehicle 1 and charging apparatus 2 via charging cable 5 is established although dependent on the distance between electric vehicle 1 and charging apparatus 2, a size of electric vehicle 1, a length of the supply line, and the like. This value of signal reception strength difference is one example when the distance between electric vehicle 1 and charging apparatus 2 is about 1 [m] and overall length of electric vehicle 1 is about 2[m] to 5 [m]. That is, by setting the reception sensitivity of the communication terminal on a signal receiving side according to this value of signal reception strength difference, first communication terminal 3a and second communication terminal 4a can communicate only while electric vehicle 1 is connected to charging apparatus 2 via charging cable 5. In other words, through setting of the reception sensitivity, communication unit 31 is configured to communicate with the destination terminal while the vehicle is connected to the supply apparatus via the supply line. Communication unit 31 is configured not to communicate with the destination terminal while the vehicle is not connected to the supply apparatus via the supply line.

Even while plug 51 of charging cable 5 is closest to charging plug socket 21, the difference of the signal reception strength when compared with the state where electric vehicle 1 and charging apparatus 2 are connected via charging cable 5 becomes equal to or larger than 20 [dB]. The reception sensitivity is set according to this difference as to allow first communication terminal 3a and second communication terminal 4a to determine whether or not electric vehicle 1 is connected to charging apparatus 2 via charging cable 5 with establishment of the communication. Therefore, the connection detector for determining whether or not electric vehicle 1 is connected to charging apparatus 2 via charging cable 5 is not included.

### <Configuration of Communication Terminal>

Communication unit 31 of electrode-attached communication terminal 3a with the above-described configuration constitutes communication terminal 30 that includes neither electrode 32 nor ground terminal 35. That is, communication terminal 30 according to the present exemplary embodiment includes communication unit 31. Communication unit 31 includes feeder connection terminal 315 electrically connected to electrode 32. In addition, communication unit 31 further includes ground connection terminal 316 electrically connected to ground terminal 35.

Connector 341 provided at an end of cable 34 opposite to electrode 32 is detachably connected to feeder connection terminal 315. That is, while connector 341 is connected to feeder connection terminal 315, feeder connection terminal 315 is electrically connected to electrode 32 via cable 34. Feeder connection terminal 315 is disposed as to be exposed from a part of case 33.

Connector 361 provided at an end of cable 36 opposite to ground terminal 35 is detachably connected to ground connection terminal 316. That is, while connector 361 is connected to ground connection terminal 316, ground connection terminal 316 is electrically connected to ground terminal 35 via cable 36. Ground terminal 35 is disposed as to be exposed from a part of case 33.

Communication terminal 30 above configured constitutes electrode-attached communication terminal 3a described above together with electrode 32 and ground terminal 35 by connecting electrode 32 to feeder connection terminal 315 and connecting ground terminal 35 to ground connection terminal 316. Therefore, when plural types of electrodes 32 exist, communication terminal 30 can connect and use arbitrary electrode 32 out of the plural types of electrodes 32. When plural types of ground terminals 35 exist, communication terminal 30 can connect and use arbitrary ground terminal 35 out of the plural types of ground terminals 35.

### <Configuration of Electrode>

A configuration of electrode 32 will be described below.

In the present exemplary embodiment, electrode 32 is a conductive sheet. Since electrode 32 is made of a conductive material, for example, electrode 32 can efficiently convert the transmission signal (electric power) that is output from transmitting circuit 311 into an electric field, and superimpose the converted transmission signal on first conductor 601 or second conductor 602 as the electric field. This is because the entire of electrode 32 made of conductive material is substantially equipotential and almost no electric loss occurs in electrode 32, hence applying the transmission signal substantially on the entire of electrode 32 uniformly without any loss. This configuration reduces the loss of the transmission signal in a communication path, for example, a path from transmitting circuit 311 to receiving circuit 412 of the destination terminal (second communication terminal 4a). Communication unit 31 can reduce electric power necessary for communication. In particular, when communication unit 31 is energized by a battery, this prolongs battery life and battery replacement cycle.

Electrode 32 may be made of a non-conductive material (electrically insulating material), such as synthetic resin, for example. Even in this case, electrode 32 can be coupled via electric field to conductive member 60. However, in electrode 32 made of an electrically insulating material, a potential on a surface of electrode 32 is not uniform, and the electric loss on the surface of electrode 32 becomes larger than a case where electrode 32 is made of a conductive material, causing a large transmission loss.

Electrode 32 is coupled via electric field to second conductor 602 by being wound around internal wire 15, as illustrated in FIG. 12. Electrode 32 is wound on sheath 155 around internal wire 15 (refer to FIG. 13A).

In other words, with respect to internal wire 15 having structure in which second conductor 602 composed of core wire 154 is covered with sheath 155, electrode 32 is disposed so as to face second conductor 602 through sheath 155 without breaking sheath 155. Therefore, a distance from electrode 32 to second conductor 602 is generally identical to thickness of sheath 155. Thus, electrode 32, which is disposed with a space of the thickness of sheath 155 from conductive member 60 (second conductor 602), is to have capacitive coupling (electric field coupling) to conductive member 60.

In the present exemplary embodiment, electrode 32 surrounds conductive member 60 in an entire circumference of a circumferential direction of conductive member 60. That is, in the case that conductive member 60 (second conductor 602) includes core wire 154 of internal wire 15, electrode 32 surrounds conductive member 60 in the entire circumference of the circumferential direction in a cross-section perpendicular to an extending direction (lengthwise direction) of internal wire 15. This configuration allows an area of electrode 32 facing conductive member 60 to be as large as possible, and reduces the transmission loss. That is, if the area of a portion of electrode 32 facing conductive member 60 increases, coupling capacitance between electrode 32 and conductive member 60 increases. The transmission loss decreases as the coupling capacitance increases. Methods for reducing the transmission loss (coupling loss) in a coupling section between electrode 32 and conductive member 60 include a method for matching impedance in addition to the above-described method. For example, by causing impedance of communication terminal 30 (communication unit 31) viewing from electrode 32 to match with impedance of electrode 32 viewed from communication terminal 30 at a frequency of the carrier wave of the transmission signal, the coupling loss decreases. As in the present exemplary embodiment, in the case where the frequency of the carrier wave is about 10 [MHz], when the impedance of communication terminal 30 viewing from electrode 32 has a value similar to that of the impedance of electrode 32 viewed from communication terminal 30 at around 10 [MHz], which is the frequency of the carrier wave, the coupling loss can be re duce d.

Electrode 32 does not necessarily conductive member 60 in the entire circumference of the circumferential direction of conductive member 60. Electrode 32 may surround conductive member 60 except for a part of the circumferential direction of conductive member 60. Accordingly, even in the case where there is no space around internal wire 15 to wind electrode 32 in the entire circumference of the circumferential direction of internal wire 15, electrode 32 can be coupled via electric field to conductive member 60.

In the present exemplary embodiment, a wiring between charging apparatus 2 and electric vehicle 1 is single-phase three-wire system 100V wiring. That is, as illustrated in FIG. 12, internal wire 15 as conductive member 60 includes neutral line 153 which is an N phase and a pair of voltage lines 151 and 152 which are an L1 phase and an L2 phase. Neutral line 153 is electrically connected, for example, to a stable potential point, such as a ground, via charging cable 5 in charging apparatus 2. That is, neutral line 153 is grounded. Neutral line 153 may be electrically connected to ground terminal 35 or ground terminal 45. This configuration causes a voltage of neutral line 153 with respect to the ground to be 0 [V], and causes a voltage of each of the pair of voltage lines 151 and 152 with respect to the ground to be 100 [V]. The voltage between one voltage line 151 (L1 phase) and neutral line 153 (N phase) becomes 100 [V]. The voltage between another voltage line 152 (L2 phase) and neutral line 153 (N phase) is 100 [V]. The voltage between the pair of voltage lines 151 and 152 is 200 [V].

That is, the resource is electric power, and conductive member 60 includes neutral line 153 and voltage lines 151 and 152. Electrode 32 is configured to be coupled via electric field only to voltage lines 151 and 152 out of neutral line 153 and voltage lines 151 and 152. In the example shown in FIG. 12, since the pair of voltage lines 151 and 152 are bundled with electrode 32, electrode 32 is wound around two (both voltage lines 151, 152) of three internal wires 15. In contrast, in the example shown in FIG. 13D, electrode 32 is wound around only one voltage line 151 out of the pair of voltage lines 151 and 152. In the example shown in FIG. 13D, electrode 32 is wound as to closely adhere to sheath 155 with almost no gap.

Thus, electrode 32 is preferably coupled via electric field only to voltage lines 151 and 152 excluding neutral line 153 out of conductive member 60. That is, in the electric field communication, since signals are transmitted using an electric field that occurs between conductive member 60 and the reference potential point, neutral line 153 which can be the reference potential point is preferably not included in conductive member 60. Electrode 32 is coupled via electric field to both of the pair of voltage lines 151 and 152, as illustrated in FIG. 12.

FIG. 13D is a perspective view of a main part of the first communication terminal according to Embodiment 5 for illustrating one example of another installation state thereof. In FIG. 13D, components identical to those of the first communication terminal illustrated in FIG. 3 are denoted by the same reference numerals. Electrode 32 illustrated in FIG. 13D is coupled via electric field to only one voltage line of the pair of voltage lines 151 and 152, and is not coupled via electric field to another voltage line out of the pair of voltage lines 151 and 152. Comparing these configurations, signal reception strength is higher in the configuration of FIG. 12 (electrode 32 is coupled via electric field to both of the pair of voltage lines 151 and 152) than in the configuration of FIG. 13D (electrode 32 is coupled via electric field to only one of the pair of voltage lines 151 and 152).

In the examples shown in FIG. 13A and FIG. 13B, electrode 32 is a mesh sheet having a strip shape, and is wound around internal wire 15 plural rolls around internal wire 15. In this configuration, electrode 32 preferably has a configuration in which an adhesive is coated on one surface in terms of workability. In this configuration, electrode 32 is relatively thin and easy to wind, and thus it is easy to wind electrode 32 around relatively thin (with a small diameter) internal wire 15 as to cause electrode 32 to closely adhere thereto.

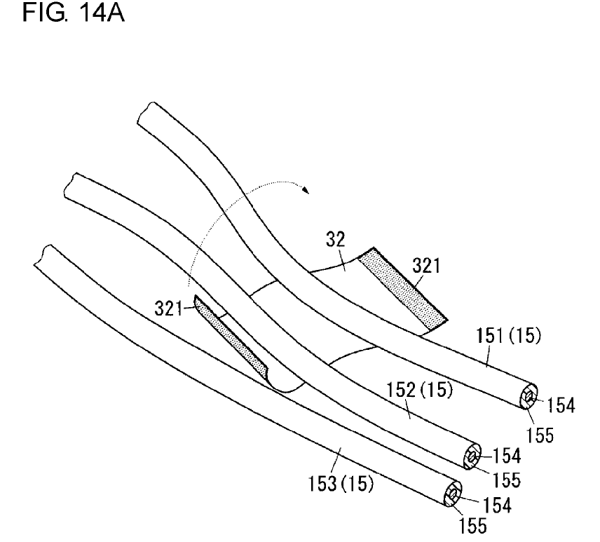

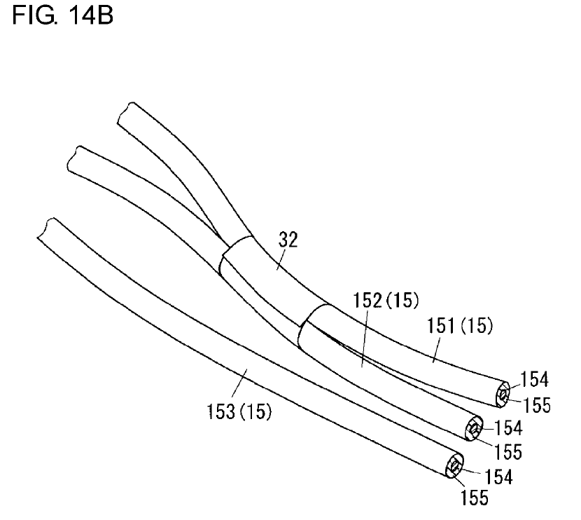

FIG. 14A and FIG. 14B are perspective views of a main part of electrode 32 according to Embodiment 5 for illustrating still another installment process thereof. In the examples shown in FIG. 14A and FIG. 14B, hook-and-loop fastener 321 is provided on both sides of electrode 32. In this configuration, electrode 32 is wound around internal wire 15 with hook-and-loop fastener 321 on both sides of electrode 32 while being rolled around internal wire 15. Since electrode 32 is detachable in this configuration, electrode-attached communication terminal 3a including electrode 32 is removed from internal wire 15 easily at a time of maintenance of electrode-attached communication terminal 3a and the like.

Electrode 32 is preferably made of a mesh metal sheet, metal foil, or metal tape as described above. This configuration allows electrode 32 to closely adhere to the surface of internal wire 15 easily, and reduces the transmission loss. In particular, the mesh metal sheet more securely adheres to the surface of internal wire 15 than the metal foil or metal tape. The mesh metal sheet can be wound around internal wire 15 with almost no air layer that lies between internal wire 15 and the metal sheet. That is, a coupling capacitance between electrode 32 and conductive member 60 is determined by a distance from electrode 32 to conductive member 60, and a dielectric constant of the substance that lies between electrode 32 and conductive member 60. The transmission loss decreases as the coupling capacitance increases. Therefore, high adhesion to internal wire 15 as electrode 32 reduces the distance from electrode 32 to conductive member 60, and prevents an air layer from lying between electrode 32 and conductive member 60, providing a large coupling capacitance and a small transmission loss.

In the case that electrode 32 is a mesh sheet, internal wire 15 is exposed from a mesh of electrode 32, resulting in that electrode 32 does not cover internal wire 15 completely. However, when a high-frequency transmission signal with the carrier wave equal to or higher than several [MHz] is used for communication, electrode 32 that fails to cover internal wire 15 completely does not much affect the transmission loss.

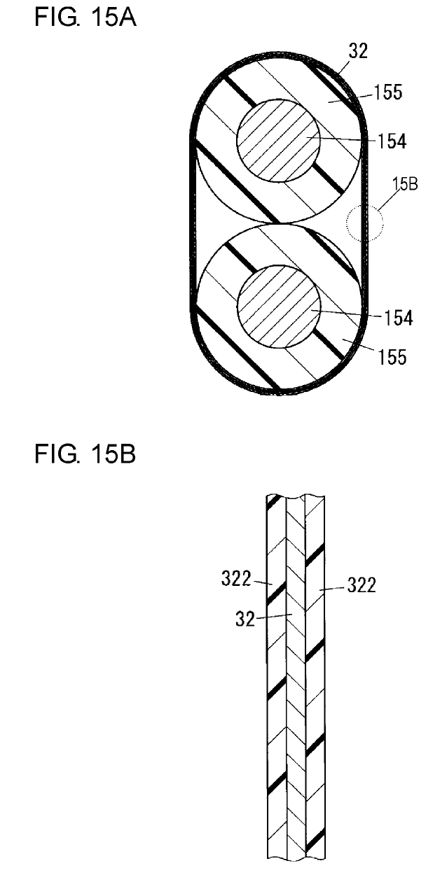

FIG. 15A is a cross-sectional view of a main part illustrating another example of electrode 32 according to Embodiment 5. FIG. 15B is an enlarged sectional view of section 15B of electrode 32 illustrated in FIG. 15A. Electrode-attached communication terminal 3a may further include electrical insulator 322 that covers electrode 32 as illustrated in FIG. 15A and FIG. 15B. In the examples shown in FIG. 15A and FIG. 15B, electrical insulator 322 made of a sheath material made of synthetic resin covers both sides of electrode 32. Electrical insulator 322 is formed, for example, by coating electrode 32 with resin or winding a tape with electrical insulation properties around electrode 32. This structure prevents electrode 32 from directly contacting a metal conductor around internal wire 15. Since electrode 32 is protected by electrical insulator 322, even when electrode 32 is made of copper or other materials, aged deterioration of electrode 32 caused by rust or the like is inhibited, resulting in that low transmission loss can be maintained over long periods. For purposes of rust prevention of electrode 32, electrical insulator 322 preferably has a water shielding property so as to prevent water from attaching to electrode 32. Electrical insulator 322 may be provided only on one side of electrode 32, and in this case, electrode 32 is wound around internal wire 15 with a surface of electrical insulator 322 being outside, and electrode 32 is not exposed from electrical insulator 322.

In the case that conductive member 60 has a linear shape or a tubular shape extending in extending direction D32, a length of electrode 32 in extending direction D32 of conductive member 60 is preferably smaller than ¼ of a wavelength of the above-described signal. In the following, the length of electrode 32 in extending direction D32 of conductive member 60 is referred to as coupling length Lc of electrode 32 (refer to FIG. 12). That is, when the signal used by electrode-attached communication terminal 3a for communication has a wavelength λ [m], coupling length Lc of electrode 32 is preferably less than λ/4 [m]. The signal wavelength λ mentioned here is a wavelength of the carrier wave (carrier) of the transmission signal. For example, when transmitting circuit 311 transmits the signal (transmission signal) by using the carrier wave of 10 [MHz] as described above, the signal wavelength λ is 30 [m]. In this case, coupling length Lc of electrode 32 is preferably less than 7.5 [m] (=30 [m]/4). In this structure, electrode 32 can hardly function as an antenna for an electromagnetic wave of the wavelength λ identical to the wavelength of the transmission signal, and electrode 32 is less susceptible to electromagnetic waves.

### <Configuration of Ground Terminal>

A configuration of ground terminal 35 will be described below.

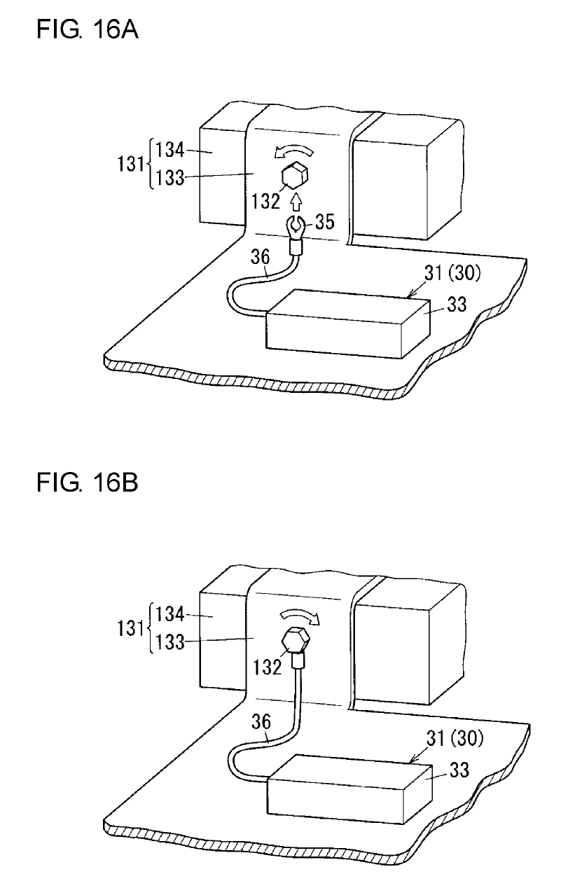

FIG. 16A and FIG. 16B are perspective views of a main part of ground terminal 35 according to Embodiment 5 for illustrating a connection process. In the present exemplary embodiment, as illustrated in FIG. 16A, ground terminal 35 includes a spade terminal that can be fixed together with conductive part 131 with screw 132 (male screw, such as hexagon head bolt and truss head screw, or female screw, such as a nut). Accordingly, ground terminal 35 is electrically connected to conductive part 131 with screw 132 fastened tightly to conductive part 131 from the beginning. That is, when installing ground terminal 35, an operator first loosens screw 132 fastened tightly to conductive part 131, as illustrated in FIG. 16A, and then, inserts ground terminal 35 into a gap formed between screw 132 and conductive part 131. In the example shown in FIG. 16A, screw 132 that fixes metal plate 133 to frame 134 (here, hexagon head bolt) is used for installing ground terminal 35. While being fixed to frame 134 with screw 132, metal plate 133 is electrically connected to frame 134. Metal plate 133 and frame 134 are included in conductive part 131.

After inserting ground terminal 35 into the gap between screw 132 and conductive part 131, as illustrated in FIG. 16B, the operator fixes ground terminal 35 together to metal plate 133 with screw 132 by fastening screw 132 tightly. At this moment, ground terminal 35 is electrically connected to metal plate 133 and frame 134 which are conductive part 131. This configuration allows ground terminal 35 to be electrically connected to conductive part 131 and to be grounded by using a fastening portion of screw 132 in conductive part 131 as a grounding point.

Ground terminal 35 is connected to conductive part 131 without processing conductive part 131. Moreover, screw 132 tightly fastened maintains a small contact resistance between ground terminal 35 and conductive part 131. In particular, since ground terminal 35 is a spade terminal, ground terminal 35 can be connected only by loosening screw 132 without removing screw 132 completely, providing preferable workability. However, the spade terminal is just an example of ground terminal 35, and may be a round terminal or any other terminal.

Conductive part 131 to which ground terminal 35 is connected is a section with conductivity, such as a metal portion that is substantially equipotential in car body 13 of electric vehicle 1 as described above. The surface area of conductive part 131 is preferably larger than the surface area of ground terminal 35. Ground terminal 35 connected to conductive part 131 provides stable electric field used for electric field communication and further improvement in the signal transmission efficiency. That is, since the electric field is not generated inside a conductor, ground terminal 35 as the reference potential point of communication unit 31 connected to conductive part 131 with a larger surface area stabilizes the electric field significantly. As a result, this configuration allows further improvement in the signal transmission efficiency.

The volume of conductive part 131 is preferably larger than the volume of ground terminal 35. Ground terminal 35 connected to conductive part 131 provides stable electric field used for electric field communication and further improvement in the signal transmission efficiency. That is, since impedance of a conductor decreases as the thickness of the conductor increases, ground terminal 35 as the reference potential point of communication unit 31 connected to conductive part 131 with a larger volume provides small impedance of the reference potential point significantly. As a result, this configuration provides stable potential of the reference potential point easily, and further improves the signal transmission efficiency.

In the present exemplary embodiment, both of the surface area and volume conductive part 131 is larger than both of the surface area and volume ground terminal 35. However, this configuration is not necessarily required, and one or both of the surface area and volume of conductive part 131 may be smaller than one or both of the surface area and volume ground terminal 35.

As another configuration example, ground terminal 35 may be a terminal that is connected to already-installed ground wiring electrically connected to conductive part 131. That is, when ground wiring connected to conductive part 131 exists near a fixing position of communication unit 31 in car body 13, ground terminal 35 is connected to this ground wiring, and is electrically connected to conductive part 131. In this case, ground terminal 35 can be, for example, with a terminal such as a screw terminal connected to a distal end of the ground wiring, an electrotap that allows the ground wiring to branch through connection in an intermediate portion of the ground wiring.

As still another configuration example, ground terminal 35 may be electrically connected to case 33 of communication unit 31. That is, in the case that case 33 is made of a conductive metal, ground terminal 35 may be electrically connected to conductive part 131 with ground terminal 35 being electrically connected to case 33 and case 33 being connected to conductive part 131. In this case, case 33 or a metal stay for installing case 33 is fastened together to conductive part 131 with screw 132, and thus ground terminal 35 is electrically connected to conductive part 131 via case 33.

The resistance between an arbitrary portion in conductive part 131 and ground terminal 35 is preferably equal to or smaller than several hundred [Ω]. This configuration increases the above-described effect produced by electrical connection of ground terminal 35 to conductive part 131.

### <Method for Installing Electrode-Attached Communication Terminal>

When installing electrode-attached communication terminal 3a, the operator fixes communication unit 31 of electrode-attached communication terminal 3a to an arbitrary position of electric vehicle 1 (vehicle), and causes electrode 32 to be coupled via electric field to conductive member 60. At this moment, the operator can cause electrode 32 to be coupled via electric field to conductive member 60 by winding electrode 32 on sheath 155 around internal wire 15.

The operator fixes communication unit 31 by fixing case 33 together with a bolt near charging inlet 12 in the car body of electric vehicle 1. A fixing position where communication unit 31 is fixed to electric vehicle 1 is determined according to a length of cable 34 as to allow cable 34 to connect communication unit 31 to electrode 32. When communication unit 31 includes a primary battery as a power supply in power supply circuit 314, the operator does not need to connect an external power source to communication unit 31 as to secure electric power for operations of communication unit 31.

The operator electrically connects ground terminal 35 to conductive part 131. At this moment, by fastening ground terminal 35 composed of a spade terminal with screw 132 together to conductive part 131 as described above, the operator can electrically connect ground terminal 35 to conductive part 131. Screw 132 fastened tight to conductive part 131 near the fixing position of communication unit 31 around charging inlet 12 allows the operator to preferably connect ground terminal 35 with screw 132.

Thus, when installing electrode-attached communication terminal 3a of the present exemplary embodiment in electric vehicle 1, the operator does not need to electrically connect electrode 32 of electrode-attached communication terminal 3a to an electric system of electric vehicle 1, and electrode-attached communication terminal 3a can be installed by relatively simple work without processing the electric system of electric vehicle 1. Therefore, when electric vehicle 1 as the vehicle has only space for installing electrode-attached communication terminal 3a, electrode-attached communication terminal 3a allows easy post-installation in electric vehicle 1 as the vehicle. The operation of connecting ground terminal 35 to conductive part 131 does not involve processing of the electric system of electric vehicle 1, and thus does not prevent post-installation of electrode-attached communication terminal 3a.

### <Configuration of Second Communication Terminal>

In the present exemplary embodiment, as described above, first communication terminal 3a provided in the vehicle and second communication terminal 4a provided in the supply apparatus have the same configuration. Therefore, the description of electrode-attached communication terminal 3a described above as first communication terminal 3a can be the description of electrode-attached communication terminal 4a as second communication terminal 4a by interpreting the vehicle (electric vehicle 1) as the supply apparatus (charging apparatus 2). Communication unit 31 (communication terminal 30), electrode 32, case 33, and cable 34 of first communication terminal 3a correspond to communication unit 41 (communication terminal 40), electrode 42, case 43, and cable 44 of second communication terminal 4a, respectively. In addition, ground terminal 35 and cable 36 of first communication terminal 3a correspond to ground terminal 45 and cable 46 of second communication terminal 4a, respectively. Transmitting circuit 311, receiving circuit 312, control circuit 313, power supply circuit 314, feeder connection terminal 315, and connector 341 correspond to transmitting circuit 411, receiving circuit 412, control circuit 413, power supply circuit 414, feeder connection terminal 415, and connector 441, respectively. Furthermore, ground connection terminal 316 and connector 361 correspond to ground connection terminal 416 and connector 461, respectively.

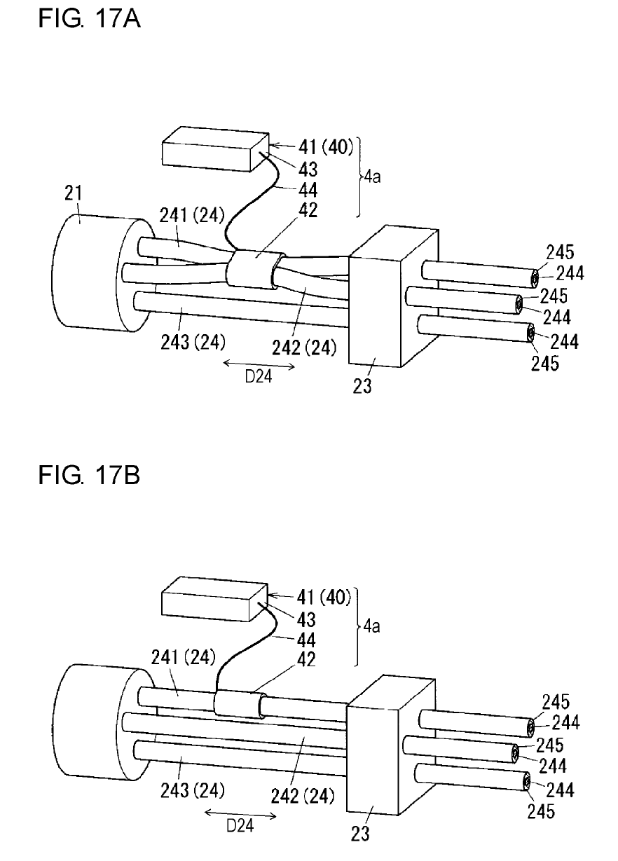

FIG. 17A is a perspective view of a main part of the installation state of the second communication terminal according to Embodiment 5 for illustrating one example of an installation state thereof. FIG. 17B is a perspective view of a main part of another installation state of the second communication terminal according to Embodiment 5 for illustrating one example of another installation state thereof. In the supply apparatus (charging apparatus 2), second conductor 603 electrically connected to first conductor 601 includes core wire 244 (refer to FIG. 17A) of internal wire 24 (refer to FIG. 17A) that electrically connects charging plug socket 21 to feeding circuit 23 in the supply apparatus. Therefore, electrode 42 of electrode-attached communication terminal 4a is coupled via electric field to second conductor 603 by being wound around internal wire 24, as illustrated in FIG. 17A and FIG. 17B. Electrode 42 is wound on sheath 245 around internal wire 24.

In accordance with the present exemplary embodiment, electrode 42 surrounds conductive member 60 in an entire circumference of a circumferential direction of conductive member 60. That is, in the case that conductive member 60 (second conductor 603) is composed of core wire 244 of internal wire 24, electrode 42 is disposed as to surround conductive member 60 in the entire circumference of the circumferential direction in a cross-section perpendicular to extending direction D24 (lengthwise direction) in which internal wire 24 extends.

In the present exemplary embodiment, since a wiring between charging apparatus 2 and electric vehicle 1 is single-phase three-wire system 100V wiring, as illustrated in FIG. 17A, internal wire 24 as conductive member 60 includes neutral line 243 which is an N phase and a pair of voltage lines 241 and 242 which are an L1 phase and an L2 phase. Neutral line 243 is electrically connected, for example, to a stable potential point, such as the ground. That is, neutral line 243 is grounded. Accordingly, a voltage of neutral line 243 with respect to the ground, which is a voltage between neutral line 243 and the stable potential point, becomes 0 [V], whereas a voltage of each of voltage lines 241 and 242 with respect to the ground, which is a voltage between the stable potential point and each of the pair of voltage lines 241 and 242, becomes 100 [V]. The voltage between one voltage line 241 (L1 phase) and neutral line 243 (N phase) becomes 100 [V]. The voltage between another voltage line 242 (L2 phase) and neutral line 243 (N phase) becomes 100 [V]. The voltage between the pair of voltage lines 241 and 242 becomes 200 [V].

That is, the resource is electric power, and conductive member 60 includes neutral line 243 and voltage lines 241 and 242. Electrode 42 is configured to be coupled via electric field only to voltage lines 241 and 242 out of neutral line 243 and voltage lines 241 and 242. Electrode 42 is not coupled via electric field to neutral line 243 substantially. In the example shown in FIG. 17A, electrode 42 is wound around two of three internal wires 24 (both voltage lines 241 and 242) to bundle the pair of voltage lines 241 and 242 with electrode 42. On the other hand, in the example shown in FIG. 17B, electrode 42 is wound only around one voltage line 241 out of the pair of voltage lines 241 and 242. In the example shown in FIG. 17B, electrode 42 is wound as to closely adhere to sheath 245 with almost no gap.

Thus, electrode 42 is preferably coupled via electric field only to voltage lines 241 and 242 out of conductive member 60 excluding neutral line 243. That is, in the electric field communication, since signals are transmitted using the electric field that occurs between conductive member 60 and the reference potential point, neutral line 243 that can be the reference potential point is preferably not included in conductive member 60. Electrode 42 may be coupled via electric field to both of the pair of voltage lines 241 and 242, as illustrated in FIG. 17A, and may be coupled via electric field only to one voltage line out of the pair of voltage lines 241 and 242, and may not be coupled via electric field to another voltage line, as illustrated in FIG. 17B. Comparing these configurations, signal reception strength will be higher in the configuration of FIG. 17A (electrode 42 is coupled via electric field to both of the pair of voltage lines 241 and 242) than in the configuration of FIG. 17B (electrode 42 is coupled via electric field to only one of the pair of voltage lines 241 and 242).

However, an aspect of the electric field coupling of electrodes 32 and 42 to conductive member 60 is preferably identical between first communication terminal 3a and second communication terminal 4a. That is, in the case that electrode 32 of first communication terminal 3a is coupled via electric field to both of the pair of voltage lines 151 and 152 (refer to FIG. 12), electrode 42 of second communication terminal 4a is preferably coupled via electric field to both of the pair of voltage lines 241 and 242 (refer to FIG. 17A). Meanwhile, in the case that electrode 32 of first communication terminal 3a is coupled via electric field to only one voltage line 151 (refer to FIG. 13D), electrode 42 of second communication terminal 4a is preferably coupled via electric field to only one voltage line 241 (refer to FIG. 17B). In the case that electrodes 32 and 42 are coupled via electric field to only one voltage line, the voltage line to which electrode 32 is coupled and the voltage line to which electrode 42 is coupled are preferably in phase with each other, but may be in different phase (L1 phase and L2 phase).

Meanwhile, as a function peculiar to second communication terminal 4a provided in charging apparatus 2, which is the supply apparatus, second communication terminal 4a may have a function to control feeding circuit 23 of charging apparatus 2. In this case, for example, by turning on and off a relay provided in feeding circuit 23, second communication terminal 4a can switch whether to supply electric power from charging apparatus 2 to electric vehicle 1, which is the vehicle. In the present exemplary embodiment, second communication terminal 4a has a function to control feeding circuit 23 of charging apparatus 2.

### <Detail of Electrode-Attached Communication Terminal>

Details of the electrode-attached communication terminal will be described below.

In the present exemplary embodiment, the reference potential point of communication unit 41 of second communication terminal 4a is grounded. Specifically, the reference potential point of communication unit 41, which serves as a circuit ground in transmitting circuit 411 and receiving circuit 412, is grounded, for example, by being electrically connected to a body with a stable potential that can be a reference, such as the ground, with an electric conductor. Since second communication terminal 4a includes ground terminal 45 which is the reference potential point of communication unit 41 similarly to first communication terminal 3a in the present exemplary embodiment, ground terminal 45 is grounded. Accordingly, communication unit 41 becomes stable because a potential of the reference potential point thereof is identical to the potential of the stable potential point, such as the ground, providing higher transmission efficiency than a case where the reference potential point is not grounded. In other words, since first communication terminal 3a and second communication terminal 4a transmit the transmission signal, for example, by using the electric field that occurs between conductive member 60 and the ground as described above, the stable reference potential point of communication unit 41 reduces the transmission loss and improves the transmission efficiency. Furthermore, the stable reference potential point of communication unit 41 reduces spurious emission.

In the present exemplary embodiment, ground terminal 45 which is the reference potential point of communication unit 41 is grounded via a frame ground of charging apparatus 2. Housing 22 of charging apparatus 2 is made of a conductive metal, and the reference potential point of feeding circuit 23 is electrically connected to housing 22. Ground terminal 45 which is the reference potential point of communication unit 41 is electrically connected to housing 22 together with the reference potential point of feeding circuit 23. Furthermore, housing 22 of charging apparatus 2 is grounded by being electrically connected to a body that has a stable potential, such as the ground, with an electric conductor. Accordingly, the reference potential point of communication unit 41 (ground terminal 45) is grounded to the body that has a stable potential, such as the ground, via housing 22, which is the frame ground of charging apparatus 2 (refer to FIG. 10). In charging apparatus 2, housing 22 may not necessarily have conductivity. When at least part of housing 22 has conductivity and functions as the frame ground, the reference potential point of communication unit 41 is grounded to the above-described body via housing 22 which is the frame ground of charging apparatus 2. This allows communication unit 41 to transmit the transmission signal by using the electric field with respect to the frame ground of charging apparatus 2 (potential of housing 22). That is, end points of electric force lines that come out of electrode 42 are converged on the frame ground of charging apparatus 2 (housing 22), and allows stable electric field and reduction in the transmission loss, improving the transmission efficiency and reducing spurious emission.

In the present exemplary embodiment, ground terminal 45 which is the reference potential point of communication unit 41 is grounded together with neutral line 243. That is, internal wire 24 as conductive member 60 in charging apparatus 2 (second conductor 603) includes neutral line 243 which is an N phase as described above. Therefore, electrode-attached communication terminal 4 has a configuration in which ground terminal 45 is electrically connected to neutral line 243 and is grounded together with neutral line 243. In the case where neutral line 243 is not grounded, when an electric field (signal) is superimposed on neutral line 243, interference may occur among plural charging apparatuses 2 via neutral line 243. The interference is likely to occur when the neutral line of the power source is common to the plural charging apparatuses 2. When neutral line 243 is grounded as in the present exemplary embodiment, the potential of neutral line 243 in plural charging apparatuses 2 is compulsorily made uniform, and an electric field (signal) component superimposed on the neutral line decreases. Communication unit 41 can transmit the transmission signal by using the electric field that occurs between neutral line 243 and each of voltage lines 241 and 242, and a distance from a starting point to end point of the electric force line becomes shorter than a case where the ground is the end point of the electric force line. Therefore, the electric force line becomes less susceptible to an obstacle or the like, provides stable electric field and reduces the transmission loss, improving the transmission efficiency. As a distance from ground terminal 45 to a grounding point of neutral line 243 decreases and a distance to charging apparatus 2 decreases, an effect of the stable electric field increases.

Furthermore, in the present exemplary embodiment, also in first communication terminal 3a provided in electric vehicle 1, ground terminal 35 is grounded together with neutral line 153 similarly to second communication terminal 4a described above. That is, internal wire 15 as conductive member 60 in electric vehicle 1 (second conductor 602) includes neutral line 153 which is an N phase as described above. Therefore, ground terminal 35 is configured to be electrically connected to neutral line 153, and to be grounded together with neutral line 153. However, unlike second communication terminal 4a, grounding mentioned here is connected not to the ground or the like, but to conductive part 131, that is, body ground. This configuration allows communication unit 31 to transmit the transmission signal by using the electric field that occurs between neutral line 153 and each of voltage lines 151 and 152, to stabilize the electric field and reduce the transmission loss, hence improving the transmission efficiency.

Alternatively, in first communication terminal 3a provided in electric vehicle 1, ground terminal 35 may be electrically insulated from neutral line 153. This configuration provides electric insulation between neutral line 153 and conductive part 131, and maintains electric insulation between secondary battery 11 and the battery for electric parts (different from secondary battery 11 for driving). That is, in general, since conductive part 131 is electrically connected to a negative terminal of the battery for electric parts, when neutral line 153 is connected to ground terminal 35, secondary battery 11 and the battery for electric parts is to be electrically connected via charging circuit 14. Meanwhile, the configuration in which ground terminal 35 is electrically insulated from neutral line 153 maintains electric insulation between secondary battery 11 and the battery for electric parts. Also, in electric vehicle 1 in which neutral line 153 is not grounded, the configuration in which ground terminal 35 is electrically insulated from neutral line 153 does not require an operation of grounding neutral line 153, that is, the operation of electrically connecting neutral line 153 to conductive part 131, thus improving workability.

### <Configuration of Communication System>

The communication system according to the present exemplary embodiment includes first communication terminal 3a and second communication terminal 4a with the above-described configurations. That is, the communication system includes first communication terminal 3a provided in the vehicle, and second communication terminal 4a provided in the supply apparatus that supplies the resource through the supply line to the vehicle. Second communication terminal 4a communicates with first communication terminal 3a.

First communication terminal 3a includes electrode 32, ground terminal 35, and communication unit 31. Electrode 32 is disposed with a space from conductive member 60 composed of at least one of first conductor 601 included in the supply line and second conductor 602 electrically connected to first conductor 601, thereby being coupled via electric field to conductive member 60. Ground terminal 35 is electrically connected to conductive part 131 made of a conductive material in the vehicle. Communication unit 31 is electrically connected to electrode 32 and ground terminal 35, operates by using ground terminal 35 as the reference potential point, and communicates with second communication terminal 4a by using the signal transmitted using conductive member 60 as a medium.

In the present exemplary embodiment, the vehicle is electric vehicle 1 having secondary battery 11 installed thereto. The supply apparatus is charging apparatus 2 that supplies electric power as the resource to the vehicle through the supply line (charging cable 5) and charges secondary battery 11.

### <Operation of Communication System>

The communication system of the present exemplary embodiment described above allows charging system 10 to perform the following operations. That is, by mutual communication between first communication terminal 3a provided in electric vehicle 1 (vehicle) and second communication terminal 4a provided in charging apparatus 2 (supply apparatus), charging system 10 can exchange signals between electric vehicle 1 and charging apparatus 2.

In charging system 10, while electric vehicle 1 is electrically connected to charging apparatus 2 via charging cable 5, electric power is supplied from feeding circuit 23 of charging apparatus 2 to charging circuit 14 of electric vehicle 1, thereby charging secondary battery 11 of electric vehicle 1. In charging apparatus 2, for example, in order to perform billing according to an amount of charging or in order to determine whether electric vehicle 1 is a vehicle that is permitted to receive electric power, performing an authentication process of electric vehicle 1 is considered. Therefore, the communication system described above allows charging system 10 to exchange signals necessary for the authenticating process of electric vehicle 1 between electric vehicle 1 and charging apparatus 2.

In a more detailed description, in charging electric vehicle 1, when electric vehicle 1 is connected via charging cable 5, charging apparatus 2 first acquires identification information from electric vehicle 1 by communication. The identification information of electric vehicle 1 is information that assigned uniquely, one-to-one to electric vehicle 1, and is registered previously in first communication terminal 3a provided in electric vehicle 1. The identification information is registered, for example, by previously being set at a time of manufacturing of first communication terminal 3a, or by being written in a memory of first communication terminal 3a with a dedicated setting device.

When electric vehicle 1 is connected to charging apparatus 2 via charging cable 5 to allow first communication terminal 3a and second communication terminal 4a to communicate with each other, first communication terminal 3a starts transmitting the identification information automatically. First communication terminal 3a repetitively transmits the identification information plural times at predetermined time intervals. Second communication terminal 4a acquires the identification information of electric vehicle 1 by receiving at least once the identification information transmitted from first communication terminal 3a. That is, first communication terminal 3a is configured to transmit the identification information uniquely assigned to the vehicle (electric vehicle 1) to second communication terminal 4a by the communication with second communication terminal 4a.

Upon acquiring the identification information of electric vehicle 1, second communication terminal 4a verifies the identification information against reference information previously registered. The reference information is formally registered identification information, and is registered previously in second communication terminal 4a provided in charging apparatus 2. The reference information is registered, for example, by being written in a memory of second communication terminal 4a. Alternatively, when second communication terminal 4a has a function to communicate with an authentication server, the reference information may be registered previously in the authentication server. In this case, second communication terminal 4a transmits the identification information of electric vehicle 1 to the authentication server, and then, the authentication server authenticates the identification information.

Second communication terminal 4a or the authentication server that authenticates the identification information determines that the verification succeeds when the registered reference information coincides with the acquired identification information. Second communication terminal 4a or the authentication server determines that the verification does not succeed when the registered reference information does not coincide with the acquired identification information. When the authentication server authenticates the identification information, the authentication server transmits information of whether the verification of the identification information succeeds or not to second communication terminal 4a as an authentication result of the identification information. Then, when the verification of the identification information succeeds, second communication terminal 4a starts supplying electric power from the supply apparatus (charging apparatus 2) to the vehicle (electric vehicle 1). On the other hand, second communication terminal 4a is configured not to cause electric power to be supplied from the supply apparatus (charging apparatus 2) to the vehicle (electric vehicle 1) when the verification of the identification information does not succeed. That is, depending on the authentication result of the identification information, second communication terminal 4a controls feeding circuit 23 of charging apparatus 2 and switches whether to supply electric power from charging apparatus 2 to electric vehicle 1.

### <Advantageous Effects>

In the configuration using wireless communications as described in PTL 2, when plural devices that can be communication partners exist near one device, it is difficult to perform one-to-one communication. For example, when two electric vehicles approach one charging apparatus, both of the two electric vehicles can communicate with the charging apparatus, and thus, it is difficult for the charging apparatus to identify which of the two electric vehicles is to be charged.

Electrode-attached communication terminal 3a, communication terminal 30, and the communication system according to the present exemplary embodiment described above can perform electric field communication with the destination terminal by using conductive member 60 as a medium with the destination terminal and exchanging signals. Since the electric field communication mentioned here mainly uses the electric field that attenuates in proportion to the third power of a distance when propagating through space, communication can be established between terminals connected via a particular communication path instead of an unspecified path in space, although non-contact. That is, in the electric field communication, since the signal that propagates through space immediately attenuates and the signal propagates mainly through conductive member 60 with little attenuation, communication between terminals connected via the particular communication path is established. Therefore, conductive member 60 as the communication path allows electrode-attached communication terminal 3a to establish communication with the destination terminal only after the vehicle is connected to the supply apparatus via the supply line (charging cable 5). As a result, even when one supply apparatus and plural vehicles exist nearby, and when plural supply apparatuses and one vehicle exist nearby, one-to-one communication can be performed.

Moreover, since electrode 32 is coupled via electric field to conductive member 60, for example, electrode 32 can positively superimpose the electric field component of the transmission signal applied by transmitting circuit 311 on second conductor 602 or first conductor 601. Since electrode 32 is coupled via electric field to conductive member 60 by being wound on the sheath around internal wire 15 or charging cable 5, electrode-attached communication terminal 3a can be easily installed in the device (vehicle) by post-installation. That is, since electrode 32 is coupled via electric field to the medium (conductive member 60), electrode-attached communication terminal 3a can communicate even if electrode 32 is not directly connected to the medium, and can be easily installed by post-installation. Since it is unnecessary to process internal wire 15 or charging cable 5 for installing electrode 32, electrode-attached communication terminal 3a once installed can be moved. Alternatively, even when electrode-attached communication terminal 3a is installed to the device (vehicle) from the beginning (at the time of manufacturing of the device), electrode-attached communication terminal 3a which requires neither soldering nor special connectors reduces installation costs or time and effort.

Furthermore, ground terminal 35 which is the reference potential point of communication unit 31 is electrically connected (grounded) to conductive part 131 of electric vehicle 1. In other words, ground terminal 35 connected to conductive part 131 causes communication unit 31 to be grounded to the body. This configuration reduces impedance of the reference potential point compared with a case where ground terminal 35 of communication unit 31 is not electrically connected to conductive part 131 (electrically isolated), and thus potential of the reference potential point is likely to be stable. This provides stable electric field near electrode 32 and reduces the transmission loss, thus improving the transmission efficiency. In addition, in the communication between first communication terminal 3a and second communication terminal 4a, electric field communication that mainly uses the electric field becomes more dominant, which reduces electromagnetic waves that do not propagate through second conductor 602 or first conductor 601 and are emitted to space, hence reducing spurious emission. This results in an advantage of stable electric field used for the electric field communication, improving the transmission efficiency of the transmission signal and reducing spurious emission.

That is, in the case where electrode-attached communication terminal 3a communicates with the destination terminal, when communication unit 31 applies a signal to electrode 32, for example, an electric field occurs between conductive member 60 and the ground, as described above. At this moment, if ground terminal 35 is not connected to conductive part 131, the entire of conductive part 131 that exists near electrode 32, neutral line 153, and the ground can become the end points of the electric force lines that start from electrode 32, which may lead to unstable electric field. In contrast, when ground terminal 35 which is the reference potential point of communication unit 31 is connected to conductive part 131, the end points of the electric force lines that start from electrode 32 are converged on conductive part 131. This results in stable electric field used for the electric field communication and improvement in the signal transmission efficiency. Also, as a surface area of conductive part 131 increases, the above-described effect produced by connecting ground terminal 35 to conductive part 131 increases. This is caused by further inhibition of ground bounce generated from an electric field coupling section.

The following describes a result of confirmation about to what extent the transmission efficiency is improved during transmission of the transmission signal from first communication terminal 3a to second communication terminal 4a, by actually electrically connecting ground terminal 35, which serves as the reference potential point of communication unit 31, to conductive part 131. Ground terminal 35 electrically connected to conductive part 131 significantly reduces the transmission loss and improves the transmission efficiency, as compared with a case where ground terminal 35 is not connected to conductive part 131. In a certain vehicle model, while the transmission loss in a case where ground terminal 35 is not connected to conductive part 131 is 50 [dB] while the transmission loss in a case where ground terminal 35 is connected to conductive part 131 is 20 [dB]. In other vehicle models, ground terminal 35 connected to conductive part 131 improves the transmission loss, for example, from 55 [dB] to 40 [dB], or improves it from 50 [dB] to 35 [dB].

Also, in the communication system according to the present exemplary embodiment, the vehicle is electric vehicle 1 having secondary battery 11 installed thereto, whereas the supply apparatus is charging apparatus 2. Charging apparatus 2 supplies electric power as the resource to the vehicle through the supply line (charging cable 5), and charges secondary battery 11. This configuration allows the communication system to perform the communication between electric vehicle 1 and charging apparatus 2 in charging system 10. Therefore, in charging system 10, for example, in order to perform billing according to the amount of charging, or in order to determine whether electric vehicle 1 is a vehicle that is permitted to be charged, thus performing the authentication process of electric vehicle 1.

Moreover, since the communication with the destination terminal is established only after the vehicle is connected to the supply apparatus via the supply line (charging cable 5), even when plural charging apparatuses 2 are installed side by side, electrode-attached communication terminal 3a can perform one-to-one communication between electric vehicle 1 and charging apparatus 2. Also, even when plural electric vehicles 1 are located near one charging apparatus 2, one-to-one communication between electric vehicle 1 and charging apparatus 2 can be performed. As a result, this communication system can perform one-to-one communication even when plural devices that can be communication partners exist near the one device.

As in the present exemplary embodiment, first communication terminal 3a is preferably configured to transmit the identification information uniquely assigned to the vehicle (electric vehicle 1) to second communication terminal 4a by communication with second communication terminal 4a. Accordingly, for example, in order to perform billing according to the amount of charging or in order to determine whether electric vehicle 1 is a vehicle that is permitted to be charged, the authentication process of electric vehicle 1 can be performed by using the identification information transmitted from first communication terminal 3a to second communication terminal 4a.

Also, second communication terminal 4a is configured not to cause electric power to be supplied from the supply apparatus (charging apparatus 2) to the vehicle (electric vehicle 1) when the verification of the identification information does not succeed. Therefore, when the verification of the identification information does not succeed due to a device other than authorized electric vehicle 1 connected or other reasons, charging apparatus 2 does not supply electric power, preventing useless electric power supply to an unauthorized device.

Meanwhile, electric vehicle 1 is used as the vehicle in the communication system, and includes first communication terminal 3a. Therefore, even when plural devices (charging apparatuses 2) that can be communication partners exist near one electric vehicle 1, electric vehicle 1 can perform one-to-one communication with charging apparatus 2 actually connected via charging cable 5.

Charging apparatus 2 is used as the supply apparatus in the communication system, and includes second communication terminal 4a. Therefore, even when plural devices (electric vehicles 1) that can be communication partners exist near one charging apparatus 2, charging apparatus 2 can perform one-to-one communication with electric vehicle 1 actually connected via charging cable 5.

Also, the vehicle is not limited to electric vehicle 1, and the supply apparatus is not limited to charging apparatus 2. In other words, the vehicle may have any configuration to receive the resource supplied from the supply apparatus through the supply line, and the resource is not limited to electric power. For example, when the resource is oil fuel, such as gasoline and diesel oil, an automobile or a two-wheel vehicle that uses oil fuel is the vehicle, whereas an oiling device is the supply apparatus. For example, in a case where the resource is gasoline and a pipe and nozzle which are supply lines of the resource are made of metal, when the nozzle is inserted into an oil filler opening of a vehicle, connection is established between the vehicle and the oiling device, and communication is established between the first communication terminal and the second communication terminal. Also, when the resource is hydrogen, a fuel cell vehicle that uses hydrogen is the vehicle, whereas a hydrogen supply device is the supply apparatus.

### Exemplary Embodiment 6

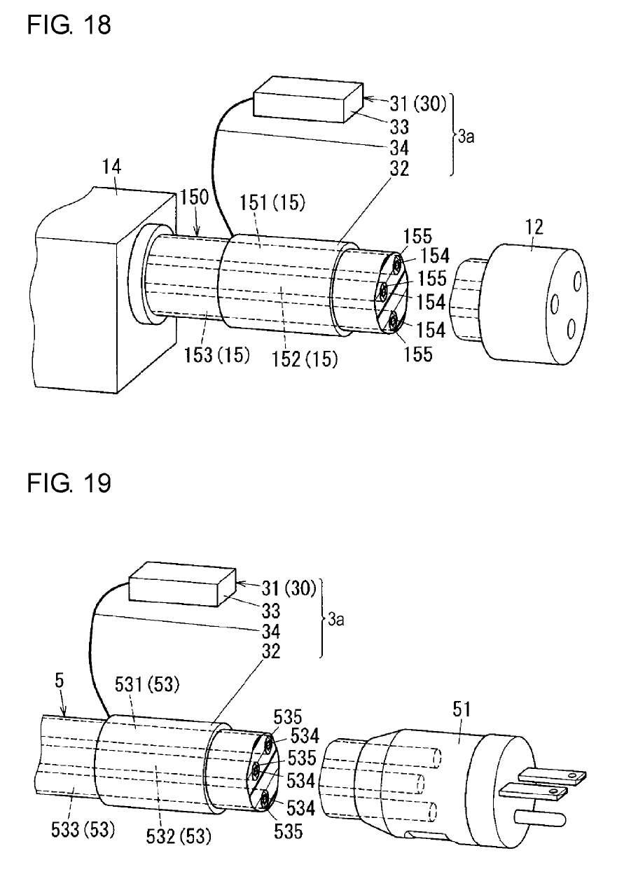

FIG. 18 is a perspective view of a main part of a first communication terminal according to Exemplary Embodiment 6 for illustrating one example of an installation state thereof. An electrode-attached communication terminal according to the present exemplary embodiment is different from the electrode-attached communication terminal according to Embodiment 5 in a coupling state of electrode 32 to conductive member 60. Hereinafter, components identical to those of the terminal according to Embodiment 5 are denoted by the same reference numerals, and their description will be omitted.

In the present exemplary embodiment, electrode 32 of electrode-attached communication terminal 3a (first communication terminal) provided in electric vehicle 1 (vehicle) is configured to be coupled via electric field to all of neutral line 153 and voltage lines 151 and 152, as illustrated in FIG. 18. That is, in the present exemplary embodiment, similarly to the terminal according to Embodiment 5, a resource exchanged between the vehicle (electric vehicle 1) and a supply apparatus (charging apparatus 2) is electric power, and conductive member 60 includes neutral line 153 and voltage lines 151 and 152. While electrode 32 is coupled via electric field only to voltage lines 151 and 152 out of neutral line 153 and voltage lines 151 and 152 according to Embodiment 5, electrode 32 is coupled via electric field to all of neutral line 153 and voltage lines 151 and 152 according to the present exemplary embodiment.

In detail, in the present exemplary embodiment, as internal wire 15 of electric vehicle 1, neutral line 153, which is N phase and one pair of voltage lines 151 and 152 which are an L1 phase and an L2 phase constitute one internal cable 150. That is, internal cable 150 includes a total of three internal wires 15 including the pair of voltage lines 151 and 152 and neutral line 153 which are covered with an insulating sheath (outer covering) and bundled into one cable. Accordingly, in the vehicle (electric vehicle 1), one internal cable 150 electrically connects charging inlet 12 to charging circuit 14. As illustrated in FIG. 18, electrode 32 is coupled via electric field to conductive member 60 (second conductor 602) by being wound on the sheath around internal cable 150 without processing internal cable 150.

The configuration of the present exemplary embodiment described above allows electrode 32 to be installed over the outer covering (sheath) of internal cable 150 even when plural internal wires 15 are bundled and constitute the cable (internal cable 150) inside the vehicle (electric vehicle 1). Therefore, an operator who installs electrode-attached communication terminal 3a can cause electrode 32 to be coupled via electric field to core wire 154 of internal wire 15 as second conductor 602 without processing internal cable 150, and allows easy post-installation in electric vehicle 1.

Meanwhile, the configuration of the present exemplary embodiment increases an effect produced by ground terminal 35 of first communication terminal 3a provided in electric vehicle 1 being grounded together with neutral line 153. That is, as in the present exemplary embodiment, in the configuration in which electrode 32 of first communication terminal 3a provided in electric vehicle 1 is coupled via electric field to neutral line 153, an electric field occurs between neutral line 153 and the ground as well. On the other hand, in charging apparatus 2 provided with second communication terminal 4a, neutral line 243 is grounded. Accordingly, a region with an unstable electric field may exist in a communication path between first communication terminal 3a and second communication terminal 4a. In this configuration, ground terminal 35 grounded (body ground) together with neutral line 153 decreases impedance of a reference potential point of communication unit 31 and provides stable electric field, thus significantly improving transmission efficiency.

Also, the configuration of the present exemplary embodiment, as described in Embodiment 5, increases an effect produced by a reference potential point of communication unit 41 grounded together with neutral line 243. This is because interference among plural charging apparatuses 2 described above occurs conspicuously in a portion of conductive member 60 that is coupled via electric field to electrode 42 because of an electric field (signal) more positively superimposed on neutral line 243. That is, in the configuration of the present exemplary embodiment, the reference potential point of communication unit 41 grounded together with neutral line 243 reduces an electric field (signal) component superimposed on neutral line 243, and significantly prevents interference among plural charging apparatuses 2.

Other configurations and functions are similar to configurations and functions of Embodiment 5.

### Exemplary Embodiment 7

FIG. 19 is a perspective view of a main part of a first communication terminal according to Exemplary Embodiment 7 for illustrating one example of an installation state thereof. An electrode-attached communication terminal according to the present exemplary embodiment is different from the electrode-attached communication terminal according to Embodiment 5 in a coupling state of electrode 32 to conductive member 60. Hereinafter, components identical to those of the terminal according to Embodiment 5 are denoted by the same reference numerals, and their description will be omitted.

In the present exemplary embodiment, as illustrated in FIG. 19, electrode 32 of electrode-attached communication terminal 3a (first communication terminal) provided in electric vehicle 1 (vehicle) is coupled via electric field to core wire 534 of electric wire 53 included in charging cable 5, which is first conductor 601. In the present exemplary embodiment, similarly to Embodiment 5, a resource exchanged between the vehicle (electric vehicle 1) and a supply apparatus (charging apparatus 2) is electric power, and conductive member 60 includes neutral line 533 and voltage lines 531 and 532. In the present exemplary embodiment, electrode 32 is coupled via electric field to all of neutral line 533 and voltage lines 531 and 532 similarly to Embodiment 6.

In detail, charging cable 5 includes neutral line 533 which is an N phase and one pair of voltage lines 531 and 532 which are an L1 phase and an L2 phase which are bundled into one cable with an insulating sheath (outer covering). Accordingly, one charging cable 5 electrically connects the vehicle (electric vehicle 1) to the supply apparatus (charging apparatus 2). As illustrated in FIG. 19, electrode 32 is coupled via electric field to conductive member 60 (first conductor 601) by being wound on the sheath around charging cable 5 without processing charging cable 5.

The configuration of the present exemplary embodiment described above allows electrode 32 to be installed over the outer covering (sheath) in charging cable 5, which is the supply line. Therefore, an operator who installs electrode-attached communication terminal 3a can cause electrode 32 to be coupled via electric field to core wire 534 of electric wire 53 as first conductor 601 without processing charging cable 5.

The configuration in which electrode 32 is installed in charging cable 5 as described in the present exemplary embodiment is particularly useful in electric vehicle 1 with the configuration in which charging cable 5 is not detachable. That is, electric vehicles 1 may not include charging inlet 12 to which connector 52 of charging cable 5 is detachably connected and employ the configuration in which charging cable 5 is electrically connected to charging circuit 14 directly. In electric vehicle 1 having such a configuration, charging cable 5 is accommodated inside car body 13 except when secondary battery 11 is charged. When secondary battery 11 is charged, charging cable 5 is pulled out of car body 13 and is connected to charging apparatus 2. In electric vehicle 1, charging cable 5 is typically provided at a position where a user of electric vehicle 1 can touch, which particularly simplifies an operation of installing electrode 32 in charging cable 5.

Meanwhile, the configuration of the present exemplary embodiment is applicable not only to first communication terminal 3a but also to second communication terminal 4a. That is, electrode 42 of electrode-attached communication terminal 4a (second communication terminal) provided in charging apparatus 2 (supply apparatus) may be coupled via electric field to core wire 534 of electric wire 53 included in charging cable 5, which is first conductor 601. This configuration is particularly useful in charging apparatus 2 with the configuration in which charging cable 5 is not detachable. That is, charging apparatuses 2 may not include charging plug socket 21 to which plug 51 of charging cable 5 is detachably connected and employ the configuration in which charging cable 5 is electrically connected to feeding circuit 23 directly. In charging apparatus 2 having such a configuration, charging cable 5 is typically provided at a position where a user of charging apparatus 2 can touch, which particularly simplifies an operation of installing electrode 42 in charging cable 5.

Other configurations and functions are similar to configurations and functions of Embodiment 5.

### Exemplary Embodiment 8

A communication system according to the present exemplary embodiment is different from the communication system according to Embodiment 5 in that only one of first communication terminal 3a and second communication terminal 4a includes electrode 32 (or 42) that is coupled via electric field to conductive member 60. Hereinafter, components identical to hose of the terminal according to Embodiment 5 are denoted by the same reference numerals, and their description will be omitted.

The present exemplary embodiment describes an example in which, only first communication terminal 3a provided in electric vehicle 1 (vehicle) out of first communication terminal 3a and second communication terminal 4a includes electrode 32. In the present exemplary embodiment, in second communication terminal 4a provided in charging apparatus 2 (supply apparatus), communication unit 41 is electrically connected directly to conductive member 60 (at least one of first conductor 601 and second conductor 603).

In this configuration, between first communication terminal 3a and second communication terminal 4a, only electrode 32 of first communication terminal 3a is coupled to conductive member 60 while not contacting the conductive member, and except for this coupling, a communication path is formed that is directly connected via conductive member 60. This results in a smaller transmission loss between first communication terminal 3a and second communication terminal 4a than a case where both electrode 32 of first communication terminal 3a and electrode 42 of second communication terminal 4a are coupled to conductive member 60 while not contacting. That is, for example, when charging apparatus 2 includes second communication terminal 4a from the beginning (at a time of manufacturing of the device), post-installation of second communication terminal 4a in the device (charging apparatus 2) is not needed. This configuration of the present exemplary embodiment reduces the transmission loss.

In this configuration, since electrode 32 of first communication terminal 3a provided in electric vehicle 1 is coupled to conductive member 60 while not contacting, electric vehicle 1 does not necessarily include first communication terminal 3a from the beginning (at the time of manufacturing of the electric vehicle). Also, processing for installing electrode 32 around a supply line through which a large electric current flows in electric vehicle 1 is unnecessary, which simplifies operation for installation of first communication terminal 3a and reduces a cost of electric vehicle 1. In particular, for a two-wheel vehicle or the like which is relatively inexpensive among electric vehicles 1, the effect of cost reduction of electric vehicle 1 is large. Also, first communication terminal 3a can be easily installed by post-installation in existing vehicles that have already appeared on the market, and is applicable to a lot of vehicle models without involving system changes.

Meanwhile, the configuration of the present exemplary embodiment is not limited to the above-described example. Only second communication terminal 4a provided in charging apparatus 2 (supply apparatus) out of first communication terminal 3a and second communication terminal 4a may include electrode 42. In this case, in first communication terminal 3a provided in electric vehicle 1 (vehicle), communication unit 31 is electrically connected directly to conductive member 60 (at least one of first conductor 601 and second conductor 602).

In this configuration, between first communication terminal 3a and second communication terminal 4a, only electrode 42 of second communication terminal 4a is coupled to conductive member 60 while not contacting the conductive member, and except for this coupling, a communication path is formed that is directly connected via conductive member 60. This results in a smaller transmission loss between first communication terminal 3a and second communication terminal 4a than a case where both electrode 32 of first communication terminal 3a and electrode 42 of second communication terminal 4a are coupled to conductive member 60 while not contacting. That is, for example, when electric vehicle 1 includes first communication terminal 3a from the beginning (at a time of manufacturing of the device), post-installation of first communication terminal 3a in the device (electric vehicle 1) is not needed, and this configuration of the present exemplary embodiment reduces the transmission loss.

Other configurations and functions are similar to configurations and functions of Embodiment 5. Also, the configuration of the present exemplary embodiment is applicable in combination with the configuration of each of Embodiments 6 and 7, in addition to the configuration of Embodiment 5.

### Exemplary Embodiment 9

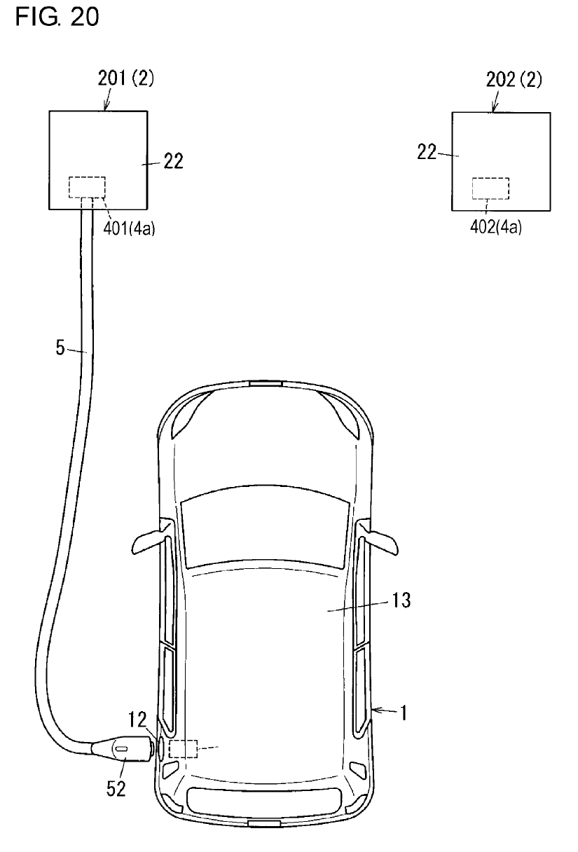

FIG. 20 is a plan view illustrating an electric vehicle and charging apparatus that use a communication system according to Exemplary Embodiment 9. The communication system according to the present exemplary embodiment is different from the communication system according to Embodiment 5 in that communication unit 31 has a function to adjust transmission strength of a signal (transmission signal) so as to prevent interference among plural charging apparatuses 2. Hereinafter, components identical to those of the terminal according to Embodiment 5 are denoted by the same reference numerals, and their description will be omitted.

In the present exemplary embodiment, as illustrated in FIG. 20, plural charging apparatuses 2, which are supply apparatuses are installed side by side. In the example illustrated in FIG. 20, as the plural supply apparatuses, charging apparatus 201 (2) and charging apparatus 202 (2) are installed side by side. Electric vehicle 1 which is a vehicle is configured to receive a resource supplied from a first supply apparatus (here, charging apparatus 201) out of the plural supply apparatuses (charging apparatuses 201 and 202).

That is, the present exemplary embodiment assumes a situation in which electric vehicle 1 is parked in a parking lot in which the plural charging apparatuses 201 and 202 are installed side by side. In this situation, electric vehicle 1 is connected via charging cable 5 to charging apparatus 201, one of the plural charging apparatuses 201 and 202. This configuration allows electric vehicle 1 to receive electric power supplied from charging apparatus 201 connected via charging cable 5. Charging apparatus 201 and charging apparatus 202 are, for example, installed next to each other and have the same configurations. Each of charging apparatus 201 and charging apparatus 202 includes second communication terminal 4a that can be a destination terminal of first communication terminal 3a. Hereinafter, to distinguish second communication terminal 4a provided in charging apparatus 201 from second communication terminal 4a provided in charging apparatus 202, second communication terminal 4a of charging apparatus 201 is referred to as “second communication terminal 401”, whereas second communication terminal 4a of charging apparatus 202 is referred to as “second communication terminal 402.”

Here, communication unit 31 of first communication terminal 3a provided in electric vehicle 1 adjusts the transmission strength of the transmission signal as to cause radiated electromagnetic field strength in another supply apparatus (charging apparatus 202) different from one supply apparatus (charging apparatus 201) out of the plural supply apparatuses to be equal to or less than a predetermined value. The following details a reason therefor.

Ground terminal 35 which is a reference potential point of communication unit 31 electrically connected to conductive part 131 improves transmission efficiency via electric field communication using conductive member 60 as a medium; however, this may simultaneously increase a radiated electromagnetic field that is output from communication unit 31 and propagates through space. This radiated electromagnetic field may also reach charging apparatus 202 to which electric vehicle 1 is not connected (another supply apparatus). When second communication terminal 402 provided in charging apparatus 202 receives this radiated electromagnetic field, interference occurs between charging apparatus 201 and charging apparatus 202. Therefore, in the present exemplary embodiment, communication unit 31 is configured to prevent interference by adjusting the transmission strength of the transmission signal as to cause the radiated electromagnetic field strength in charging apparatus 202 to be equal to or less than the predetermined value.

In more detail, communication unit 31 adjusts the transmission strength (transmission power) of the transmission signal in transmitting circuit 311 as to cause the radiated electromagnetic field strength near electrode 42 of second communication terminal 402 in charging apparatus 202, which is a second supply apparatus, to be equal to or less than the predetermined value. This configuration allows charging apparatuses 201 and 202 to isolate the transmission signal from electric vehicle 1 connected via charging cable 5 (hereinafter referred to as “desired signal”) from a transmission signal from electric vehicle 1 that is not connected (hereinafter referred to as “leakage signal”). This prevents interference between plural charging apparatuses 2.

Here, the predetermined value that is an upper limit of the radiated electromagnetic field strength in second communication terminal 402 may be previously determined and stored in a memory of second communication terminal 402, and may be a value that changes in response to an operation of a variable resistor or the like. The predetermined value may be 10 [dBpV/m]. Example 1 and Example 2 of the predetermined value of the present exemplary embodiment will be described below.

### Example 1

In Example 1, the predetermined value is determined as to cause reception strength of the transmission signal (reception power) in second communication terminal 402 provided in charging apparatus 202 (second supply apparatus) to be smaller than reception strength in second communication terminal 401 provided in charging apparatus 201 (first supply apparatus). This configuration produces a difference in the reception strength of the transmission signal transmitted from first communication terminal 3a between charging apparatus 201 and charging apparatus 202. In other words, a value obtained by converting the radiated electromagnetic field strength near second communication terminal 402 of charging apparatus 202 into the reception strength of the transmission signal in second communication terminal 402 becomes lower than the reception strength of the transmission signal in second communication terminal 401. An antenna gain of electrode 42 may be reflected on the converted value.

In this case, second communication terminal 4a can distinguish the desired signal from the leakage signal, for example, by comparing the reception strength of the transmission signal with a predetermined threshold. That is, by determining that the transmission signal is the desired signal when the reception strength of the transmission signal is equal to or higher than the threshold, and by determining that the transmission signal is the leakage signal when the reception strength is lower than the threshold, second communication terminal 4a can extract only the desired signal, thereby suppressing interference.

Also, comparing the transmission signal received by second communication terminal 401 with the transmission signal received by second communication terminal 402 also allows the desired signal to be distinguished from the leakage signal. In this case, for example, a higher level apparatus capable of communicating with both second communication terminals 401 and 402 compares the reception strength of the transmission signal between both second communication terminals 401 and 402. That is, when second communication terminal 401 and second communication terminal 402 receive the signal transmitted from one electric vehicle 1 simultaneously, the higher level apparatus compares the reception strength of the transmission signal in second communication terminal 401 with the reception strength of the transmission signal in second communication terminal 402. Then, the higher level apparatus determines that second communication terminal 4a with the higher reception strength receives the desired signal, and that second communication terminal 4a with the lower reception strength receives the leakage signal, thereby suppressing interference.

In this configuration, since a difference only needs to arise in the reception strength of the transmission signal between charging apparatus 201 and charging apparatus 202, communication unit 31 of first communication terminal 3a can set relatively high transmission strength of the transmission signal. Therefore, Example 1 provides relatively high reception strength of the transmission signal (desired signal) in second communication terminal 401 and high transmission efficiency between electric vehicle 1 and charging apparatus 201 which are connected via charging cable 5.

### Example 2

In Example 2, the predetermined value is set to cause the reception strength of the transmission signal in second communication terminal 402 provided in charging apparatus 202 (another supply apparatus) to be lower than reception sensitivity of second communication terminal 402. The reception sensitivity mentioned here is the minimum reception strength that allows second communication terminal 402 to secure reception quality required for communication. That is, second communication terminal 402 does not primarily receive the transmission signal whose reception strength is lower than the reception sensitivity as a signal. Here, the reception sensitivity is equal between second communication terminal 401 and second communication terminal 402. In other words, the value obtained by converting the radiated electromagnetic field strength near second communication terminal 402 of charging apparatus 202 into the reception strength of the transmission signal in second communication terminal 402 becomes lower than the reception sensitivity of second communication terminal 4a. An antenna gain of electrode 42 may be reflected on the converted value.

In this case, since second communication terminal 4a does not receive the leakage signal as a signal, second communication terminal 4a can receive only the desired signal. That is, unlike Example 1, Example 2 allows second communication terminal 4a to extract only the desired signal without distinguishing the desired signal from the leakage signal by comparison of the reception strength of the transmission signal, thereby suppressing interference. Therefore, Example 2 simplifies processes after receipt of the transmission signal.

In the present exemplary embodiment, plural charging apparatuses 2, which are plural supply apparatuses, only need to be installed side by side, and the number of charging apparatuses 2 is not limited to two but may be three or more. For example, when six charging apparatuses 2 are installed side by side, one electric vehicle 1 is connected to one charging apparatus 2 out of these six charging apparatuses 2 via charging cable 5, and receives a resource (electric power) supplied from one connected charging apparatus 2. Therefore, one charging apparatus 2 out of these six charging apparatuses 2 which is connected to electric vehicle 1 via charging cable 5 is one supply apparatus. In this case, other supply apparatuses are other charging apparatuses 2 different from the one supply apparatus described above, and are not required to be adjacent to charging apparatus 2 as the one supply apparatus.

Other configurations and functions are similar to configurations and functions of Embodiment 5. The configuration of the present exemplary embodiment is applicable in combination with the configuration of each of Embodiments 6, 7, and 8, in addition to the configuration of Embodiment 5.

### Exemplary Embodiment 10

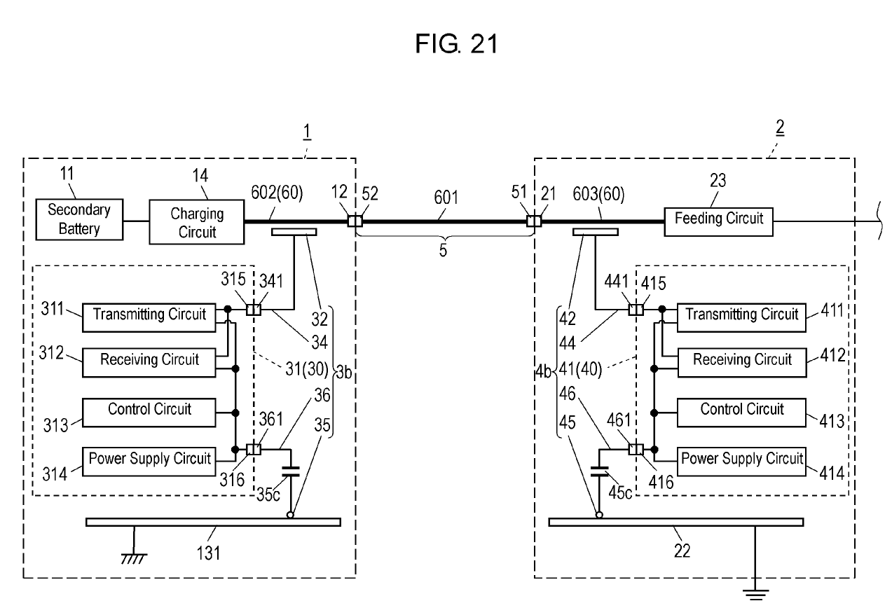

FIG. 21 is a block diagram of a communication system according to Exemplary Embodiment 10. In FIG. 21, components identical to those of the system according to Embodiment 5 illustrated in FIG. 10 are denoted by the same reference numerals. The communication system illustrated in FIG. 21 includes communication terminals 3b and 4b instead of communication terminals 3 and 4 of the communication system according to Embodiment 5 illustrated in FIG. 11.

Communication terminal 3b further includes grounding capacitor 35c connected in series between ground connection terminal 361 of communication unit 31 and ground terminal 35 of communication terminal 3 illustrated in FIG. 11. In other words, ground terminal 35 connected to conductive part 131 allows communication unit 31 to be grounded to the body via grounding capacitor 35c in high-frequencies although communication unit 31 is not grounded to the body in a direct-current frequency. This configuration reduces impedance of a reference potential point of communication unit 31 compared with a case where ground terminal 35 of communication unit 31 is not electrically connected to conductive part 131 (electrically isolated), hence providing a stable potential of the reference potential point of communication unit 31.

Communication terminal 4b further includes grounding capacitor 45c connected in series between ground connection terminal 416 of communication unit 41 and ground terminal 45 of communication terminal 4 illustrated in FIG. 11. In other words, ground terminal 45 connected to housing 22 allows communication unit 41 to be grounded to the body via grounding capacitor 45c in high frequencies although communication unit 41 is not grounded to the body in a direct-current frequency. This configuration reduces impedance of the reference potential point of communication unit 41 compared with a case where ground terminal 45 of communication unit 41 is not electrically connected to housing 22 (electrically isolated), thus providing a stable potential of the reference potential point of communication unit 41.

In the communication system illustrated in FIG. 21, both communication terminals 3 and 4 of the communication system according to Embodiment 5 illustrated in FIG. 11 are replaced by communication terminals 3b and 4b. In the communication system according to Embodiment 10, communication terminal 3 out of communication terminals 3 and 4 of the communication system according to Embodiment 5 illustrated in FIG. 11 may be replaced by communication terminal 3b and may constitute the communication system together with communication terminal 4. Also, communication terminal 4 out of communication terminals 3 and 4 of the communication system according to Embodiment 5 illustrated in FIG. 11 may be replaced by communication terminal 4b and may constitute the communication system together with communication terminal 3.

Grounding capacitor 35c produces a similar effect by being connected in series between the reference potential point of communication unit 31 and ground terminal 35, instead of between ground connection terminal 361 of communication unit 31 and ground terminal 35. For example, grounding capacitor 35c may be connected in series between connection terminal 316 and each of reference potential point 311a of transmitting circuit 311, reference potential point 312a of receiving circuit 312, reference potential point 313a of control circuit 313, and reference potential point 314a of power supply circuit 314. Grounding capacitor 45c produces a similar effect by being connected in series between the reference potential point of communication unit 41 and ground terminal 45, instead of between ground connection terminal 416 of communication unit 41 and ground terminal 45. For example, grounding capacitor 45c may be connected in series between ground connection terminal 416 and each of reference potential point 411a of transmitting circuit 411, reference potential point 412a of receiving circuit 412, reference potential point 413a of control circuit 413, and reference potential point 414a of power supply circuit 414.

Other configurations and functions are similar to configurations and functions of Embodiment 5. The configuration of the present exemplary embodiment is applicable in combination with the configuration of each of Embodiments 6, 7, 8, and 9, in addition to the configuration of Embodiment 5.

### REFERENCE MARKS IN THE DRAWINGS

1 electric vehicle (vehicle, first device)
2 charging apparatus (supply apparatus, second device)
3 first communication terminal (electrode-attached communication terminal)
4 second communication terminal (electrode-attached communication terminal)
5 charging cable (supply line)
31, 41 communication unit (first communication unit, second communication unit)
32, 42 electrode (first electrode, second electrode)
35 ground terminal
60 conductive member
131 conductive part
151, 152, 241, 242, 531, 532 voltage line
153, 243, 533 neutral line
315, 415 connection terminal
322 electrical insulator
601 first conductor
602 second conductor

1. An electrode-attached communication terminal comprising:
a communication unit provided in a first device, the communication unit being configured to communicate with a destination terminal provided in each of one or more second devices that exchanges a resource with the first device through a supply line; and
an electrode disposed with a space from a conductive member including at least one of a first conductor included in the supply line and a second conductor electrically connected to the first conductor, the electrode being configured to be coupled via electric field to the conductive member,
wherein the communication unit is electrically connected to the electrode and is configured to communicate with the destination terminal by using a signal transmitted via the conductive member as a medium.

2. The electrode-attached communication terminal according to claim 1,
wherein the resource is electric power,
wherein the conductive member includes a neutral line and a voltage line,
wherein the first conductor is one of the neutral line and the voltage line, and
wherein the electrode is configured to be coupled via electric field to both the neutral line and the voltage line.

3. The electrode-attached communication terminal according to claim 1,
wherein the resource is electric power,
wherein the conductive member includes a neutral line and a voltage line,
wherein the first conductor is the voltage line, and
wherein the electrode is configured to be coupled via electric field to only the voltage line out of the neutral line and the voltage line.

4. The electrode-attached communication terminal according to claim 1, wherein the communication unit is configured:
to communicate with the destination terminal while the first device is connected to the one or more second devices through the supply line; and
not to communicate with the destination terminal while the first device is not connected to the one or more second devices through the supply line.

5. The electrode-attached communication terminal according to claim 1, further comprising
a ground terminal constituting a reference potential point of the communication unit,
wherein the communication unit is electrically connected to the electrode and the ground terminal, and is configured to communicate with the destination terminal by using the signal transmitted via the conductive member as a medium,
wherein the first device includes a conductive part made of conductive material, and
wherein the ground terminal is electrically connected to the conductive part of the first device.

6. The electrode-attached communication terminal according to claim 5, wherein a surface area of the conductive part is larger than a surface area of the ground terminal.

7. The electrode-attached communication terminal according to claim 5, wherein a volume of the conductive part is larger than a volume of the ground terminal.

8. The electrode-attached communication terminal according to claim 5,
wherein the one or more second devices comprise a plurality of second devices each including the destination terminal,
wherein the first device is configured to receive the resource from one second device out of the plurality of second devices, and
wherein the communication unit adjusts a transmission strength of the signal as to cause radiation electromagnetic field strength from a further second device out of the plurality of second devices different from the one second device to be equal to or lower than a predetermined value.

9. The electrode-attached communication terminal according to claim 8, wherein the predetermined value is determined so as to cause reception strength of the signal at the destination terminal provided in the further second device to be lower than reception sensitivity at the destination terminal provided in the one second device.

10. The electrode-attached communication terminal according to claim 8, wherein the predetermined value is set so as to cause reception strength at the signal in the destination terminal provided in the further second device to be lower than reception sensitivity at the destination terminal provided in the further second device.

11. The electrode-attached communication terminal according to claim 5,
wherein the resource is electric power,
wherein the conductive member includes a neutral line and a voltage line,
wherein the first conductor is one of the neutral line and the voltage line, and
wherein the electrode is configured to be coupled via electric field to both the neutral line and the voltage line.

12. The electrode-attached communication terminal according to claim 5,
wherein the resource is electric power,
wherein the conductive member includes a neutral line and a voltage line,
wherein the first conductor is the voltage line, and
wherein the electrode is configured to be coupled via electric field to only the voltage line out of the neutral line and the voltage line.

13. The electrode-attached communication terminal according to claim 11, wherein the ground terminal is grounded together with the neutral line.

14. The electrode-attached communication terminal according to claim 11, wherein the ground terminal is electrically insulated from the neutral line.

15. The electrode-attached communication terminal according to claim 11, wherein a reference potential point of the communication unit is grounded together with the neutral line.

16. The electrode-attached communication terminal according to claim 1, wherein the electrode is configured to be coupled via electric field to the conductive member by being capacitively coupled to the conductive member.

17. The electrode-attached communication terminal according to claim 1, wherein the electrode surrounds the conductive member along an entire circumference of the conductive member in a circumferential direction of the conductive member.

18. The electrode-attached communication terminal according to claim 1, wherein the electrode surrounds the conductive member except for a part of the conductive member in a circumferential direction of the conductive member.

19. The electrode-attached communication terminal according to claim 1,
wherein the conductive member has a linear shape or a tubular shape extending in an extending direction, and
wherein a length of the electrode in the extending direction of the conductive member is less than ¼ of a wavelength of the signal.

20. The electrode-attached communication terminal according to claim 1, wherein the electrode is a conductive sheet.

21. The electrode-attached communication terminal according to claim 1, further comprising an electrical insulator covering the electrode.

22. The electrode-attached communication terminal according to claim 1, wherein a reference potential point of the communication unit is grounded.

23. The electrode-attached communication terminal according to claim 22, wherein the reference potential point of the communication unit is grounded via a frame ground of the first device.

24. An electric vehicle functioning as the first device of the electrode-attached communication terminal according to claim 1.

25. A charging apparatus functioning as one of the one or more second devices of the electrode-attached communication terminal according to claim 1.

26. A communication terminal comprising a communication unit provided in a first device, the communication unit being configured to communicate with a destination terminal provided in a second device that exchanges a resource with the first device through a supply line,
wherein the communication unit includes a connection terminal configured to be electrically connected to an electrode,
wherein the electrode is disposed with a space from a conductive member including at least one of a first conductor included in the supply line and a second conductor electrically connected to the first conductor, the electrode being configured to be coupled via electric field to the conductive member, and
wherein the communication unit is configured to communicate with the destination terminal by using a signal transmitted via the conductive member as a medium.

27. The communication terminal according to claim 26,
wherein the communication unit further includes a ground connection terminal configured to be electrically connected to a ground terminal,
wherein the ground terminal is electrically connected to a conductive part of the first device, the conductive part being made of conductive material, and
wherein the communication unit is configured to operate with the ground terminal as a reference potential point and to communicate with the destination terminal by using the signal.

28. A communication system comprising:
a first communication terminal provided in a first device; and
a second communication terminal provided in a second device, the second communication terminal being configured to exchange a resource with the first device through a supply line and to communicate with the first communication terminal,
wherein one of the first communication terminal and the second communication terminal includes:
a first electrode disposed with a space from a conductive member including at least one of a first conductor included in the supply line and a second conductor electrically connected to the first conductor, the first electrode being coupled via electric field to the conductive member; and
a first communication unit electrically connected to the first electrode, the first communication unit being configured to communicate with another of the first communication terminal and the second communication terminal by using a signal transmitted via the conductive member as a medium.

29. The communication system according to claim 28, wherein the another of the first communication terminal and the second communication terminal includes:
a second electrode disposed with a space from the conductive member, the second electrode being coupled via electric field to the conductive member; and
a second communication unit electrically connected to the second electrode, the second communication unit configured to communicate with the one of the first communication terminal and the second communication terminal by using the signal transmitted via the conductive member as a medium.

30. The communication system according to claim 28,
wherein the first device is an electric vehicle including a secondary battery,
wherein the resource is electric power, and
wherein the second device is a charging apparatus that supplies the resource to the first device through the supply line as to charge the secondary battery.

31. The communication system according to claim 30, wherein the first communication terminal is configured to transmit, to the second communication terminal, identification information dedicated to the first device by communicating with the second communication terminal.

32. The communication system according to claim 31, wherein, when verification of the identification information does not succeed, the second communication terminal does not supply the resource from the second device to the first device.

33. The communication system according to claim 28,
wherein the first device includes a conductive part made of conductive material,
wherein the first device further includes a ground terminal electrically connected to the conductive part, and
wherein the communication unit is electrically connected to the electrode and the ground terminal, the communication unit operating with the ground terminal as a reference potential point.

34. The communication system according to claim 28,
wherein the first device is an electric vehicle including a secondary battery, and
wherein the second device is a charging apparatus that supplies electric power as the resource to the electric vehicle through the supply line as to charge the secondary battery.

35. The communication system according to claim 34, wherein the first communication terminal is configured to transmit, to the second communication terminal, identification information dedicated to the electric vehicle by communicating with the second communication terminal.

36. The communication system according to claim 35, wherein the second communication terminal is configured:
to supply the resource from the charging apparatus to the electric vehicle when verification of the identification information succeeds; and
not to supply the resource from the charging apparatus to the electric vehicle when the verification of the identification information does not succeed.

37. An electric vehicle functioning as the first device of the communication system according to claim 28.

38. A charging apparatus functioning as the second device of the communication system according to claim 28.

39. The electrode-attached communication terminal according to claim 12, wherein the ground terminal is grounded together with the neutral line.

40. The electrode-attached communication terminal according to claim 12, wherein the ground terminal is electrically insulated from the neutral line.

41. The electrode-attached communication terminal according to claim 12, wherein a reference potential point of the communication unit is grounded together with the neutral line.
